(19) United States
(12) Patent Application Publication
(10) Pub. No.: US 2026/0255274 A1
(43) Pub. Date: Aug. 27, 2026

(54) FAST WAKEUP AND DATA TRANSMISSION METHODS FOR WIRELESS COMMUNICATIONS, AND APPARATUSES, SYSTEMS, AND NON-TRANSITORY COMPUTER-READABLE STORAGE DEVICES EMPLOYING SAME

(71) Applicant: Huawei Administration Building, Bantian, Shenzhen (CN)

(72) Inventors: Jianglei Ma, Ottawa (CA); Hao Tang, Ottawa (CA); Xiaoyan Bi, Ottawa (CA); Huazi Zhang, Zhejiang (CN); Peiying Zhu, Ottawa (CA); Wen Tong, Ottawa (CA)

(21) Appl. No.: 19/643,506

(22) Filed: Apr. 9, 2026

Related U.S. Application Data
(63) Continuation of application No. PCT/CN2024/073106, filed on Jan. 18, 2024.
(60) Provisional application No. 63/543,378, filed on Oct. 10, 2023.

(51) Int. Cl. H04W 52/02; H04W 28/08

(52) U.S. Cl. CPC H04W 52/0235; H04W 28/0942

(57) ABSTRACT

A method applied in a first communication-node side, such as for execution by a transmit-and-receive point (TRP) or a component thereof, for wireless communication with a second communication node such as a user equipment (UE), at least one of the first and second communication nodes being in reduced power consumption for wireless communication related activities, the method has the steps of: transmitting to the second communication node a wakeup signal in accordance with a first set of communication-related information, the wakeup signal comprising control information; and transmitting to the second communication node a first data set in accordance with the control information in the wakeup signal and a second set of communication-related information determined before the transmission of the wakeup signal.

### CROSS-REFERENCE TO RELATED APPLICATIONS

This application is a continuation of International Application No. PCT/CN2024/073106, filed on January 18, 2024, which claims priority to US Provisional Patent Application Serial No. 63/543,378, filed October 10, 2023. All of the aforementioned patent applications are hereby incorporated by reference in their entireties.

### TECHNICAL FIELD

The present disclosure relates generally to communication systems, apparatuses, methods, and non-transitory computer-readable storage devices, and in particular to fast wakeup and data transmission methods for wireless communications, and apparatuses, systems, and non-transitory computer-readable storage devices employing same.

### BACKGROUND

Wireless communication systems such as mobile communication systems are known. In wireless communication systems, power consumption is generally an important concern especially to user equipments (UEs).

For example, in existing mobile communication systems such as fifth-generation (5G) new radio (NR), a UE with reduced or no activity, for example when the node does not have data to receive from other nodes or data to send to other nodes, may enter the inactive or idle state for power savings. However, waking up a UE in the inactive or idle state generally requires the UE to perform many steps which may cause significant power consumption and/or increased latency. In addition, a UE in connected state may also be able to enter different power consumption modes, such as deep sleeping, light sleeping, micro-sleeping, with different levels of power consumption.

On the network side, a base station (BS; also called a transmit-and-receive point (TRP)) may also enter a sleep mode for power savings. Similarly, waking up a TRP in sleep mode may require the TRP to perform many steps which may cause significant power consumption and/or increased latency.

In next-generation mobile communication systems such as the sixth-generation (6G) systems, power saving may be a fundamental design requirement. Therefore, there is a desire for novel methods of waking up a UE and/or a TRP with further reduced power consumption.

### SUMMARY

Embodiments of this disclosure relate to systems, apparatuses, methods, and non-transitory computer-readable storage devices employing a fast wakeup and data transmission method for wireless communications.

According to one aspect of this disclosure, there is provided a first method applied in a first communication-node side for wireless communication with a second communication node, at least one of the first and second communication nodes being in reduced power consumption for wireless communication related activities, the method comprising: transmitting to the second communication node a wakeup signal in accordance with a first set of communication-related information, the wakeup signal comprising control information; and transmitting to the second communication node a first data set in accordance with the control information in the wakeup signal and a second set of communication-related information.

In some embodiments, the first data set is transmitted without a channel measurement period before the transmission of the first data set and after the transmission of the wakeup signal.

In some embodiments, the second set of communication-related information was determined before the transmission of the wakeup signal.

In some embodiments, the at least one of the first and second communication nodes is in a sleep state during the transmission of the wakeup signal and the transmission of the first data set.

In some embodiments, the first method further comprises: transmitting to or receiving from the second communication node a first signal for keeping the second communication node alive.

In some embodiments, the first method further comprises: receiving from the second communication node a response to the transmitted first signal; or receiving from the second communication node another first signal.

In some embodiments, the first method further comprises: transmitting to the second communication node a response to the received first signal; or transmitting to the second communication node another first signal.

In some embodiments, the first signal is for performing measurements, tracking a location of the second communication node, and/or maintaining synchronization between the first and second communication nodes.

In some embodiments, the measurements comprise channel measurements and/or sensing measurements.

In some embodiments, said maintaining synchronization comprises one or more time advance measurements.

In some embodiments, the first signal is a signal with reduced power.

In some embodiments, the first signal is an on-off keying signal, a frequency-shift keying signal, a phase-shift keying signal, a chirp signal, a frequency modulated continuous wave signal, or a passive signal.

In some embodiments, the first and second sets of communication-related information are stored in a communication-parameter map.

In some embodiments, the communication-parameter map comprises one or more entries, each entry comprising communication-related information for one or more zones of an area.

In some embodiments, the first and second sets of communication-related information are stored in the communication-parameter map before the transmission of the wakeup signal and/or before the at least one of the first and second communication nodes reduced the power consumption thereof for wireless communication related activities.

In some embodiments, the communication-related information comprises ray tracing or multi-path information, channel information, beamforming information of one or more beams, multiple-input-multiple-output related information, an initial modulation-and-coding-scheme, a path loss, and/or one or more initial power-control parameters.

In some embodiments, the beamforming information of each of the one or more beams comprises an absolute beam angle, a relative beam angle, a beam gradient, and/or a beam width.

In some embodiments, the initial power control comprises one or more power-control parameters obtained from a path loss estimation (such as a long-term path loss estimation), and one or more predefined transmission parameters.

In some embodiments, at least a portion of the communication-parameter map around a position of the second communication node is stored in the second communication node.

In some embodiments, the communication-parameter map or the control information of the wakeup signal comprises timing indication, and one or more initial transmission parameters.

In some embodiments, the one or more initial transmission parameters comprise modulation-and-coding-scheme, quasi co-located beamforming, and/or one or more quality-of-service related parameters.

In some embodiments, the one or more quality-of-service related parameters comprise one or more latency requirements, and/or one or more reliability requirements.

In some embodiments, the wakeup signal and the first data set are separated by an automatic gain control signal.

In some embodiments, the automatic gain control signal is after the wakeup signal in time by a first time gap.

In some embodiments, the control information of the wakeup signal comprises an indication of a time-frequency resource for transmitting the first data set.

In some embodiments, the indication of the time-frequency resource comprises indication of one or more slots, bandwidth, and/or carrier index for transmitting the first data set.

In some embodiments, the wakeup signal comprises: a first-stage signal for waking up the second communication node; and a second-stage signal comprising the control information.

In some embodiments, the second-stage signal further comprises a positioning reference signal and/or a channel state information reference signal.

In some embodiments, the second-stage signal further comprises an absolute timing reference.

In some embodiments, the first data set comprises one or more reference signals.

In some embodiments, the one or more reference signals comprise one or more demodulation reference signals, one or more channel state information reference signals, and/or one or more phase tracking reference signals.

In some embodiments, the first method further comprises: receiving a feedback from the second communication node in response to the first data set.

In some embodiments, the feedback comprises uplink control information and/or uplink data.

In some embodiments, the feedback is after the first data set in time with a second time gap therebetween.

In some embodiments, a starting time of the feedback is after a starting time of the first data set.

In some embodiments, the first method further comprises: updating the second set of communication-related information based on channel measurements received from the second communication node.

In some embodiments, the first method further comprises: transmitting to the second communication node a second data set based on the updated second set of communication-related information.

In some embodiments, the updated second set of communication-related information comprises: the updated channel measurements, and/or optimization of a connection between the first and second communication nodes.

In some embodiments, the optimization of the connection between the first and second communication nodes comprises: beamforming optimization, multiple-input-multiple-output optimization, modulation-and-coding-scheme adjustment, and link adaption.

In some embodiments, the first data set is transmitted using a first beam and the second data set is transmitted using a second beam, an angular width of the first beam being narrower than that of the second beam.

In some embodiments, the first data set is transmitted using a multiple-input-multiple-output setting reduced from a maximum multiple-input-multiple-output capacity.

In some embodiments, the second data set is after the feedback in time with a third time gap therebetween.

In some embodiments, said transmitting to the second communication node the first data set comprises: transmitting to the second communication node, based on the second set of communication-related information, a physical downlink shared channel signal comprising the first data set.

In some embodiments, the first method further comprises: transmitting to the second communication node the first data set using rateless coding and based on the second set of communication-related information.

In some embodiments, the first communication node is a transmit-and-receive point and the second communication node is a user equipment.

According to one aspect of this disclosure, there is provided one or more circuits for performing the above-described first method.

According to one aspect of this disclosure, there is provided one or more processors functionally connected to one or more memories for performing the above-described first method.

According to one aspect of this disclosure, there is provided an apparatus comprising: one or more processors functionally connected to one or more memories for performing the above-described first method.

According to one aspect of this disclosure, there is provided one or more non-transitory computer-readable storage devices comprising computer-executable instructions, wherein the instructions, when executed, cause one or more circuits to perform the above-described first method.

According to one aspect of this disclosure, there is provided a second method applied in a second communication-node side for wireless communication with a first communication node, at least one of the first and second communication nodes being in reduced power consumption for wireless communication related activities, the second method comprising: receiving from the first communication node a wakeup signal based on a first set of communication-related information, the wakeup signal comprising control information; and receiving from the first communication node a first data set based on the control information in the wakeup signal and a second set of communication-related information.

In some embodiments, the first data set is received without a channel measurement period before the transmission of the first data set and after the transmission of the wakeup signal.

In some embodiments, the second set of communication-related information was determined before the transmission of the wakeup signal.

In some embodiments, the at least one of the first and second communication nodes is in a sleep state during the transmission of the wakeup signal and the transmission of the first data set.

In some embodiments, the second method further comprises: transmitting to or receiving from the first communication node a first signal for keeping the second communication node alive.

In some embodiments, the second method further comprises: receiving from the first communication node a response to the transmitted first signal; or receiving from the first communication node another first signal.

In some embodiments, the second method further comprises: transmitting to the first communication node a response to the received first signal; or transmitting to the first communication node another first signal.

In some embodiments, the first signal is for performing measurements, tracking a location of the second communication node, and/or maintaining synchronization between the first and second communication nodes.

In some embodiments, the measurements comprise channel measurements and/or sensing measurements.

In some embodiments, said maintaining synchronization comprises one or more time advance measurements.

In some embodiments, the first signal is a signal with reduced power.

In some embodiments, the first signal is an on-off keying signal, a frequency-shift keying signal, a phase-shift keying signal, a chirp or frequency modulated continuous wave signal, or a passive signal.

In some embodiments, the first and second sets of communication-related information are stored in a communication-parameter map.

In some embodiments, the communication-parameter map comprises one or more entries, each entry comprising communication-related information for one or more zones of an area.

In some embodiments, the first and second sets of communication-related information are stored in the communication-parameter map before the transmission of the wakeup signal and/or before the at least one of the first and second communication nodes reduced the power consumption thereof for wireless communication related activities.

In some embodiments, the communication-related information comprises ray tracing or multi-path information, channel information, beamforming information of one or more beams, multiple-input-multiple-output related information, an initial modulation-and-coding-scheme, a path loss, and/or one or more initial power-control parameters.

In some embodiments, the beamforming information of each of the one or more beams comprises an absolute beam angle, a relative beam angle, a beam gradient, and/or a beam width.

In some embodiments, the initial power control comprises one or more power-control parameters obtained from a path loss estimation (such as a long-term path loss estimation), and one or more predefined transmission parameters.

In some embodiments, at least a portion of the communication-parameter map around a position of the second communication node is stored in the second communication node.

In some embodiments, the communication-parameter map or the control information of the wakeup signal comprises timing indication, and one or more initial transmission parameters.

In some embodiments, the one or more initial transmission parameters comprise a modulation-and-coding-scheme, quasi co-located beamforming, and/or one or more quality-of-service related parameters.

In some embodiments, the one or more quality-of-service related parameters comprise one or more latency requirements, and/or one or more reliability requirements.

In some embodiments, the wakeup signal and the first data set are separated by an automatic gain control signal.

In some embodiments, the automatic gain control signal is after the wakeup signal in time by a first time gap.

In some embodiments, the control information of the wakeup signal comprises an indication of a time-frequency resource for transmitting the first data set.

In some embodiments, the indication of the time-frequency resource comprises indication of one or more slots, bandwidth, and/or carrier index for transmitting the first data set.

In some embodiments, the wakeup signal comprises: a first-stage signal for waking up the second communication node; and a second-stage signal comprising the control information.

In some embodiments, the second-stage signal further comprises a positioning reference signal and/or a channel state information reference signal.

In some embodiments, the second-stage signal further comprises an absolute timing reference.

In some embodiments, the first data set comprises one or more reference signals.

In some embodiments, the one or more reference signals comprise one or more demodulation reference signals, one or more channel state information reference signals, and/or one or more phase tracking reference signals.

In some embodiments, the second method further comprises: transmitting to the first communication node a feedback in response to the first data set.

In some embodiments, the feedback comprises uplink control information and/or uplink data.

In some embodiments, the feedback is after the first data set in time with a second time gap therebetween.

In some embodiments, a starting time of the feedback is after a starting time of the first data set.

In some embodiments, the second method further comprises: performing channel measurements; transmitting to the first communication node results of the channel measurements; and receiving updated second set of communication-related information from the first communication node.

In some embodiments, the second method further comprises: receiving from the first communication node a second data set based on the updated second set of communication-related information.

In some embodiments, the updated second set of communication-related information comprises: the updated channel measurements, and/or optimization of a connection between the first and second communication nodes.

In some embodiments, the optimization of the connection between the first and second communication nodes comprises: beamforming optimization, multiple-input-multiple-output optimization, modulation-and-coding-scheme adjustment, and link adaption.

In some embodiments, the first data set is transmitted using a first beam and the second data set is transmitted using a second beam, an angular width of the first beam being narrower than that of the second beam.

In some embodiments, the first data set is transmitted using a multiple-input-multiple-output setting reduced from a maximum multiple-input-multiple-output capacity.

In some embodiments, the second data set is after the feedback in time with a third time gap therebetween.

In some embodiments, said receiving from the first communication node the first data set comprises: receiving from the first communication node, based on the second set of communication-related information, a physical downlink shared channel signal comprising the first data set.

In some embodiments, the second method further comprises: receiving from the first communication node the first data set using rateless coding and based on the second set of communication-related information.

In some embodiments, the first communication node is a transmit-and-receive point and the second communication node is a user equipment.

According to one aspect of this disclosure, there is provided one or more circuits for performing the above-described second method.

According to one aspect of this disclosure, there is provided one or more processors functionally connected to one or more memories for performing the above-described second method.

According to one aspect of this disclosure, there is provided an apparatus comprising: one or more processors functionally connected to one or more memories for performing the above-described second method.

According to one aspect of this disclosure, there is provided one or more non-transitory computer-readable storage devices comprising computer-executable instructions, wherein the instructions, when executed, cause one or more circuits to perform the above-described second method.

According to one aspect of this disclosure, there is provided a third method applied in a first communication-node side for wireless communication with a second communication node, at least one of the first and second communication nodes being in reduced power consumption for wireless communication related activities, the third method comprising: receiving from the second communication node a preamble based on a first set of communication-related information; and receiving from the second communication node a first data set based on a second set of communication-related information.

In some embodiments, the first data set is received without a channel measurement period before the transmission of the first data set and after the transmission of the preamble.

In some embodiments, the second set of communication-related information was determined before the transmission of the preamble.

In some embodiments, the at least one of the first and second communication nodes is in a sleep state during the transmission of the preamble and the transmission of the first data set.

In some embodiments, the third method further comprises: transmitting to or receiving from the second communication node a first signal for keeping the second communication node alive.

In some embodiments, the third method further comprises: receiving from the second communication node a response to the transmitted first signal; or receiving from the second communication node another first signal.

In some embodiments, the third method further comprises: transmitting to the second communication node a response to the received first signal; or transmitting to the second communication node another first signal.

In some embodiments, the first signal is for performing measurements, tracking a location of the second communication node, and/or maintaining synchronization between the first and second communication nodes.

In some embodiments, the measurements comprise channel measurements and/or sensing measurements.

In some embodiments, said maintaining synchronization comprises one or more time advance measurements.

In some embodiments, the first signal is a signal with reduced power.

In some embodiments, the first signal is an on-off keying signal, a frequency-shift keying signal, a phase-shift keying signal, a chirp or frequency modulated continuous wave signal, or a passive signal.

In some embodiments, the first and second sets of communication-related information are stored in a communication-parameter map.

In some embodiments, the communication-parameter map comprises one or more entries, each entry comprising communication-related information for one or more zones of an area.

In some embodiments, the first and second sets of communication-related information are stored in the communication-parameter map before the transmission of the preamble and/or before the at least one of the first and second communication nodes reduced the power consumption thereof for wireless communication related activities.

In some embodiments, the communication-related information comprises ray tracing or multi-path information, channel information, beamforming information of one or more beams, multiple-input-multiple-output related information, an initial modulation-and-coding-scheme, a path loss, and/or one or more initial power-control parameters.

In some embodiments, the beamforming information of each of the one or more beams comprises an absolute beam angle, a relative beam angle, a beam gradient, and/or a beam width.

In some embodiments, the one or more initial power control comprises one or more power-control parameters obtained from a path loss estimation (such as a long-term path loss estimation), and one or more predefined transmission parameters.

In some embodiments, at least a portion of the communication-parameter map around a position of the second communication node is stored in the second communication node.

In some embodiments, the communication-parameter map comprises timing indication, and one or more initial transmission parameters.

In some embodiments, the one or more initial transmission parameters comprise a modulation-and-coding-scheme, quasi co-located beamforming, and/or one or more quality-of-service related parameters.

In some embodiments, the one or more quality-of-service related parameters comprise one or more latency requirements, and/or one or more reliability requirements.

In some embodiments, the preamble and the first data set are separated by an automatic gain control signal.

In some embodiments, the automatic gain control signal is after the preamble in time by a first time gap.

In some embodiments, the first data set is transmitted using grant-free resource.

In some embodiments, the first data set comprises one or more reference signals.

In some embodiments, the one or more reference signals comprise one or more demodulation reference signals, one or more channel state information reference signals, and/or one or more phase tracking reference signals.

In some embodiments, the third method further comprises: transmitting to the second communication node a feedback in response to the first data set.

In some embodiments, the feedback comprises downlink control information and/or downlink acknowledgement.

In some embodiments, the feedback is after the first data set in time with a second time gap therebetween.

In some embodiments, a starting time of the feedback is after a starting time of the first data set.

In some embodiments, the third method further comprises: performing channel measurements; updating the second set of communication-related information based on results of the channel measurements; and transmitting to the second communication node the updated second set of communication-related information.

In some embodiments, the third method further comprises: receiving from the second communication node a second data set based on the updated second set of communication-related information.

In some embodiments, the updated second set of communication-related information comprises: the updated channel measurements, and/or optimization of a connection between the first and second communication nodes.

In some embodiments, the optimization of the connection between the first and second communication nodes comprises: beamforming optimization, multiple-input-multiple-output optimization, modulation-and-coding-scheme adjustment, and link adaption.

In some embodiments, the first data set is transmitted using a first beam and the second data set is transmitted using a second beam, an angular width of the first beam being narrower than that of the second beam.

In some embodiments, the first data set is transmitted using a multiple-input-multiple-output setting reduced from a maximum multiple-input-multiple-output capacity.

In some embodiments, the second data set is after the feedback in time with a third time gap therebetween.

In some embodiments, the first communication node is a transmit-and-receive point and the second communication node is a user equipment.

According to one aspect of this disclosure, there is provided one or more circuits for performing the above-described third method.

According to one aspect of this disclosure, there is provided one or more processors functionally connected to one or more memories for performing the above-described third method.

According to one aspect of this disclosure, there is provided an apparatus comprising: one or more processors functionally connected to one or more memories for performing the above-described third method.

According to one aspect of this disclosure, there is provided one or more non-transitory computer-readable storage devices comprising computer-executable instructions, wherein the instructions, when executed, cause one or more circuits to perform the above-described third method.

According to one aspect of this disclosure, there is provided a fourth method applied in a second communication-node side for wireless communication with a first communication node, at least one of the first and second communication nodes being in reduced power consumption for wireless communication related activities, the fourth method comprising: receiving from the first communication node a preamble based on a first set of communication-related information; and transmitting to the second communication node a first data set based on a second set of communication-related information.

In some embodiments, the first data set is transmitted without a channel measurement period before the transmission of the first data set and after the transmission of the preamble.

In some embodiments, the second set of communication-related information was determined before the transmission of the preamble.

In some embodiments, the at least one of the first and second communication nodes is in a sleep state during the transmission of the preamble and the transmission of the first data set.

In some embodiments, the fourth method further comprises: transmitting to or receiving from the first communication node a first signal for keeping the second communication node alive.

In some embodiments, the fourth method further comprises: receiving from the first communication node a response to the transmitted first signal; or receiving from the first communication node another first signal.

In some embodiments, the fourth method further comprises: transmitting to the first communication node a response to the received first signal; or transmitting to the first communication node another first signal.

In some embodiments, the first signal is for performing measurements, tracking a location of the second communication node, and/or maintaining synchronization between the first and second communication nodes.

In some embodiments, the measurements comprise channel measurements and/or sensing measurements.

In some embodiments, said maintaining synchronization comprises one or more time advance measurements.

In some embodiments, the first signal is a signal with reduced power.

In some embodiments, the first signal is an on-off keying signal, a frequency-shift keying signal, a phase-shift keying signal, a chirp or frequency modulated continuous wave signal, or a passive signal.

In some embodiments, the first and second sets of communication-related information are stored in a communication-parameter map.

In some embodiments, the communication-parameter map comprises one or more entries, each entry comprising communication-related information for one or more zones of an area.

In some embodiments, the first and second sets of communication-related information are stored in the communication-parameter map before the transmission of the preamble and/or before the at least one of the first and second communication nodes reduced the power consumption thereof for wireless communication related activities.

In some embodiments, the communication-related information comprises ray tracing or multi-path information, channel information, beamforming information of one or more beams, multiple-input-multiple-output related information, an initial modulation-and-coding-scheme, a path loss, and/or one or more initial power-control parameters.

In some embodiments, the beamforming information of each of the one or more beams comprises an absolute beam angle, a relative beam angle, a beam gradient, and/or a beam width.

In some embodiments, the initial power control comprises one or more power-control parameters obtained from a path loss estimation (such as a long-term path loss estimation), and one or more predefined transmission parameters.

In some embodiments, at least a portion of the communication-parameter map around a position of the second communication node is stored in the second communication node.

In some embodiments, the communication-parameter map comprises timing indication, one or more of initial transmission parameters.

In some embodiments, the one or more initial transmission parameters comprise a modulation-and-coding-scheme, quasi co-located beamforming, and/or one or more quality-of-service related parameters.

In some embodiments, the one or more quality-of-service related parameters comprise one or more latency requirements, and/or one or more reliability requirements.

In some embodiments, the preamble and the first data set are separated by an automatic gain control signal.

In some embodiments, the automatic gain control signal is after the preamble in time by a first time gap.

In some embodiments, the first data set is transmitted using grant-free resource.

In some embodiments, the first data set comprises one or more reference signals.

In some embodiments, the one or more reference signals comprise one or more demodulation reference signals, one or more channel state information reference signals, and/or one or more phase tracking reference signals.

In some embodiments, the fourth method further comprises: receiving a feedback from the second communication node in response to the first data set.

In some embodiments, the feedback comprises downlink control information and/or downlink acknowledgement.

In some embodiments, the feedback is after the first data set in time with a second time gap therebetween.

In some embodiments, a starting time of the feedback is after a starting time of the first data set.

In some embodiments, the fourth method further comprises: receiving from the first communication node updated second set of communication-related information obtained based on channel measurements.

In some embodiments, the fourth method further comprises: transmitting to the first communication node a second data set based on the updated second set of communication-related information.

In some embodiments, the updated second set of communication-related information comprises: the updated channel measurements, and/or optimization of a connection between the first and second communication nodes.

In some embodiments, the optimization of the connection between the first and second communication nodes comprises: beamforming optimization, multiple-input-multiple-output optimization, modulation-and-coding-scheme adjustment, and link adaption.

In some embodiments, the first data set is transmitted using a first beam and the second data set is transmitted using a second beam, an angular width of the first beam being narrower than that of the second beam.

In some embodiments, the first data set is transmitted using a multiple-input-multiple-output setting reduced from a maximum multiple-input-multiple-output capacity.

In some embodiments, the second data set is after the feedback in time with a third time gap therebetween.

In some embodiments, the first communication node is a transmit-and-receive point and the second communication node is a user equipment.

According to one aspect of this disclosure, there is provided one or more circuits for performing the above-described fourth method.

According to one aspect of this disclosure, there is provided one or more processors functionally connected to one or more memories for performing the above-described fourth method.

According to one aspect of this disclosure, there is provided an apparatus comprising: one or more processors functionally connected to one or more memories for performing the above-described fourth method.

According to one aspect of this disclosure, there is provided one or more non-transitory computer-readable storage devices comprising computer-executable instructions, wherein the instructions, when executed, cause one or more circuits to perform the above-described fourth method.

According to one aspect of this disclosure, there is provided an apparatus, and configured to perform the any one of above mentioned methods and their embodiments. Specifically, the apparatus includes one or more units configured to perform the any one of above mentioned methods and their embodiments.

According to one aspect of this disclosure, there is provided a computer-readable storage medium. The computer-readable storage medium stores a computer program, and when the computer program is executed by an apparatus, the apparatus is enabled to implement the any one of above mentioned methods and their embodiments.

According to one aspect of this disclosure, there is provided a computer program product including one or more instructions. When the instructions are executed by a computer, the apparatus is enabled to implement the any one of above mentioned methods and their embodiments.

According to one aspect of this disclosure, there is provided a computer program. When the computer program is executed by a computer, an apparatus is enabled to implement the any one of above mentioned methods and their embodiments.

According to one aspect of this disclosure, there is provided a communication system. The communication system includes a first communication-node and/or a second communication-node, the first communication-node is configured to perform the method regarding with the first communication-node as stated above, and the second communication-node is configured to perform the method regarding with the second communication-node as stated above.

According to one aspect of this disclosure, there is provided an apparatus for implementing the method in any possible implementation of the foregoing aspects.

The systems, apparatuses, methods, and non-transitory computer-readable storage devices disclosed herein provide various benefits such as:

a device in a status of reduced power consumption may “wake up and go”, that is, transmitting/receiving data after wakeup without entering a status of full power consumption, thereby greatly saving energy;

during the “wake up and go”, the device may progressively adapt to the channel by repeated performing channel measurements.

### BRIEF DESCRIPTION OF THE DRAWINGS

For a more complete understanding of this disclosure, reference is made to the following description and accompanying drawings, in which:

FIGS. 1A and 1B are simplified schematic diagrams showing the structure of a communication system, according to some embodiments of this disclosure;

FIG. 2A is a simplified schematic diagram showing a user equipment (UE), a terrestrial transmit-and-receive point (T-TRP), and a non-terrestrial transmit-and-receive points (NT-TRP) of the communication system shown in FIG. 1A;

FIG. 2B is a simplified schematic diagram showing units or modules in a device, such as in UE or in TRP of the communication system shown in FIG. 1A;

FIG. 3 is a simplified schematic diagrams showing the structure of the communication system shown in FIG. 1A for integrated sensing and communication (ISAC) using a plurality of sensing and communication (SAC) nodes, according to some embodiments of this disclosure;

FIG. 4 is a simplified schematic diagram showing a sensing management function (SMF) of the communication system shown in FIG. 1A, implemented as a physically independent entity;

FIG. 5 is a schematic diagram showing the radio resource control (RRC) states of a UE in fifth generation (5G) new radio (NR);

FIG. 6A is a schematic diagram showing the states of a device such as a UE or a TRP, according to some embodiments of this disclosure;

FIG. 6B is a schematic diagram showing the states of a device such as a UE or a TRP, according to some other embodiments of this disclosure;

FIG. 7 is a schematic diagram showing an example of a communication-parameter map and a geographic map related thereto;

FIGS. 8A to 8E show some examples of the use of life cycle management (LCM) signals, according to some embodiments of this disclosure;

FIG. 9 is a flowchart showing the steps of a fast wakeup and downlink (DL) data transmission method, according to some embodiments of this disclosure;

FIG. 10 is a schematic diagram showing the structure of the DL data burst used in the method shown in FIG. 9, according to some embodiments of this disclosure;

FIG. 11 is a schematic diagram showing the structure of the fast-wakeup signal of the DL data burst shown in FIG. 10;

FIG. 12 is a schematic diagram showing a DL data field of the DL data burst shown in FIG. 10, according to some embodiments of this disclosure;

FIG. 13 is a schematic diagram showing a DL data field of the DL data burst shown in FIG. 10, according to some other embodiments of this disclosure;

FIG. 14 is a schematic diagram showing an example for illustrating the location and boundary alignment of one DL data burst (having the structure shown in FIG. 10) in the time-frequency plane;

FIG. 15 is a schematic diagram showing the structure of the DL data burst used in the method shown in FIG. 9, according to some embodiments of this disclosure;

FIG. 16 is a flowchart showing the steps of a fast wakeup and uplink (UL) data transmission method, according to some embodiments of this disclosure;

FIG. 17 is a schematic diagram showing the structure of the UL data burst used in the method shown in FIG. 16, according to some embodiments of this disclosure;

FIG. 18 is a schematic diagram showing the structure of the UL data burst used in the method shown in FIG. 16, according to some other embodiments of this disclosure;

FIG. 19 is a schematic diagram showing the structure of the UL data burst used in the method shown in FIG. 16, according to yet some other embodiments of this disclosure;

FIG. 20 is a flowchart showing the steps of a fast wakeup and UL data transmission method, according to some embodiments of this disclosure;

FIG. 21A is a schematic diagram showing the structure of the UL and DL data bursts used in the method shown in FIG. 20, which gives rise to a full-duplex (FD) or subband-FD fast-wakeup and data-transmission, according to some embodiments of this disclosure;

FIG. 21B is a schematic diagram showing the structure of the DL/UL data bursts used in the method shown in FIG. 20, according to some other embodiments of this disclosure;

FIG. 22 is a flowchart showing the steps generalizing those of the fast wakeup and data transmission methods shown in FIGS. 9, 16, and 20, according to some embodiments of this disclosure;

FIGS. 23 and 24 are flowcharts showing the details of the fast wakeup and DL data transmission method (corresponding to the fast wakeup and DL data transmission method shown in FIG. 9) performed by a TRP and a UE, respectively, according to some embodiments of this disclosure;

FIGS. 25 and 26 are flowcharts showing the details of the fast wakeup and UL transmission method (corresponding to the fast wakeup and UL data transmission method shown in FIG. 16) performed by a UE and a TRP, respectively, according to some embodiments of this disclosure.

### DETAILED DESCRIPTION

### A. SYSTEM STRUCTURE

### A-1. GENERAL SYSTEM STRUCTURE

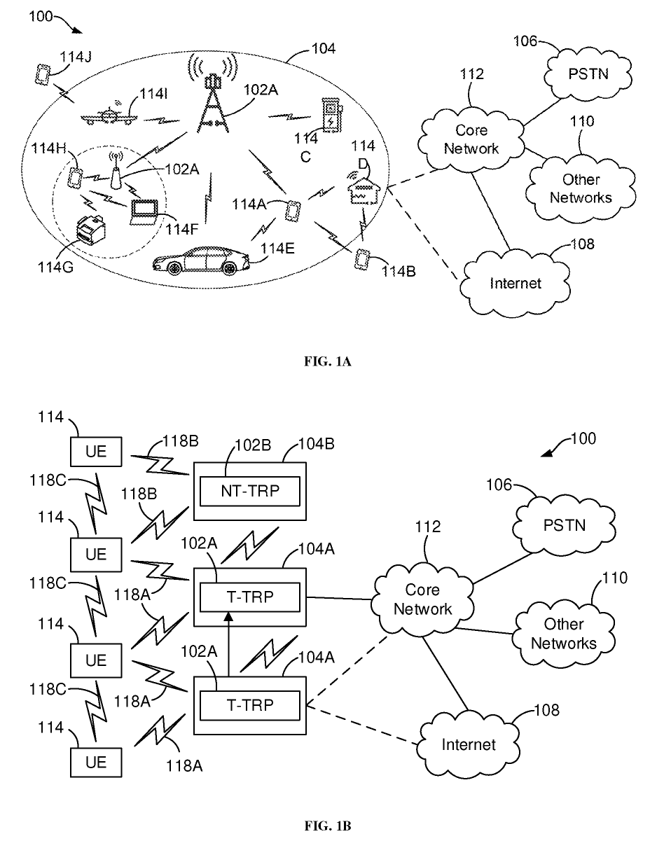

Referring to FIG. 1A, as an illustrative example without limitation, a simplified schematic illustration of a communication system is provided. The communication system 100 comprises a radio access network (RAN) 104. The RAN 104 may be a next generation (for example, sixth generation (6G) or later) RAN, or a legacy (for example, fifth-generation (5G), fourth-generation (4G), third-generation (3G), or second-generation (2G)) RAN. One or more user equipments (UEs) 114A to 114J (generically referred to as 114) may be interconnected to one another or connected to one or more network nodes 102A in the RAN 104. A core network 112 may be a part of the communication system and may be dependent or independent of the radio access technology used in the communication system 100. Also, the communication system 100 comprises a public switched telephone network (PSTN) 106, the internet 108, and other networks 110.

FIG. 1B illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, and unicast, and/or the like. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, and/or the like). The communication system 100 may provide a high degree of availability and robustness through a joint operation of the terrestrial communication system and the non-terrestrial communication system. For example, integrating a non-terrestrial communication system (or components thereof) into a terrestrial communication system may result in what may be considered a heterogeneous network comprising multiple layers. As those skilled in the art will appreciate, the heterogeneous network may achieve improved overall performance through efficient multi-link joint operation, more flexible functionality sharing, and faster physical layer link switching between terrestrial networks and non-terrestrial networks.

The terrestrial communication system and the non-terrestrial communication system may be considered sub-systems of the communication system 100. In the example shown, the communication system 100 includes UEs 114, RANs 104A (also called “terrestrial communication networks”), non-terrestrial communication networks 104B, a core network 112, a public switched telephone network (PSTN) 106, the internet 108, and other networks 110. The RANs 104A include respective base stations (BSs) 102A, which may be generically referred to as terrestrial transmit-and-receive points (T-TRPs) 102A. The non-terrestrial communication network 104B includes an access node 102B, which may be generically referred to as a non-terrestrial transmit-and-receive point (NT-TRP) 102B. The T-TRPs 102A and the NT-TRP 102B may be generally referred to as TRPs or access nodes 102.

Any UE 114 may be alternatively or additionally configured to interface, access, or communicate with any other T-TRP 102A and NT-TRP 102B, the internet 108, the core network 112, the PSTN 106, the other networks 110, or any combination of the preceding. In some examples, UE 114 may communicate an uplink (UL) and/or downlink (DL) transmission over a terrestrial interface 118A with T-TRP 102A. In some examples, a UE 114 may communicate a UL and/or DL transmission over a non-terrestrial interface 118B with NT-TRP 102B. In some examples, the UEs 114 may also communicate directly with one another via one or more sidelink air interfaces 118C.

The air interfaces 118A and 118C may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA; also known as discrete Fourier transform spread OFDMA, DFT-s-OFDMA) in the air interfaces 118A and 118C. The air interfaces 118A and 118C may utilize other higher dimension signal spaces, which may involve a combination of orthogonal and/or non-orthogonal dimensions.

The non-terrestrial air interface 118B may enable communication between a UE 114 and one or multiple NT-TRPs 102B via a wireless link or simply a link. For some examples, the link is a dedicated connection for unicast transmission, a connection for broadcast transmission, or a connection between a group of UEs 114 and one or multiple NT-TRPs 102B for multicast transmission.

The RANs 104A are in communication with the core network 112 to provide the UEs 114 with various services such as voice, data, and other services. The RANs 104A and/or the core network 112 may be in direct or indirect communication with one or more other RANs (not shown), which may or may not be directly served by core network 112, and may or may not employ the same radio access technology as RANs 104A. The core network 112 may also serve as a gateway access between (i) the RANs 104A, or UEs 114, or both, and (ii) other networks (such as the PSTN 106, the internet 108, and the other networks 110). In addition, some or all of the UEs 114 may include functionality for communicating with different wireless networks over different wireless links using different wireless technologies and/or protocols. Instead of wireless communication (or in addition thereto), the UEs 114 may communicate via wired communication channels to a service provider or switch (not shown), and to the internet 108. PSTN 106 may include circuit switched telephone networks for providing plain old telephone service (POTS). Internet 108 may include a network of computers and subnets (intranets) or both, and incorporate protocols, such as internet protocol (IP), transmission control protocol (TCP), user datagram protocol (UDP). UEs 114 may be multimode devices capable of operation according to multiple radio access technologies, and incorporate multiple transceivers necessary to support such.

### A-2. BASIC COMPONENT STRUCTURE

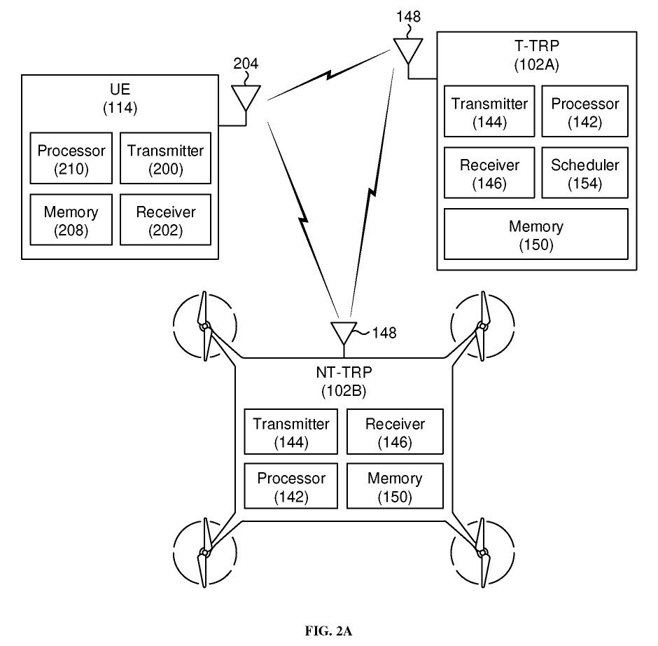

FIG. 2A illustrates an example of a UE 114, a T-TRP 102A, and a NT-TRP 102B. The UE 114 is used to connect persons, objects, machines, and/or the like. The UE 114 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, and/or the like.

Each UE 114 represents any suitable end-user device for wireless operation and may include such devices (or may be referred to) as a user device, a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, a wearable device (such as a watch, a pair of glasses, a head mounted equipment, and/or the like), an industrial device, a robot, or apparatus (for example, communication module, modem, or chip) in or comprising the foregoing devices, among other possibilities. Future generation UEs 114 may be referred to using other terms. Each UE 114 connected to T-TRP 102A and/or NT-TRP 102B may be dynamically or semi-statically turned-on (that is, established, activated, or enabled), turned-off (that is, released, deactivated, or disabled) and/or configured in response to one or more of: connection availability and connection necessity.

The T-TRP 102A may be known by other names in some implementations, such as a base station, a base transceiver station (BTS), a radio base station, a network node, a network device, a device on the network side, a transmit/receive node, a Node B, an evolved NodeB (eNodeB or eNB), a home eNodeB, a next generation NodeB (gNB), a transmission point (TP), a site controller, an access point (AP), or a wireless router, a relay station, a remote radio head, a terrestrial node, a terrestrial network device, or a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 102A may be macro BSs, pico BSs, relay node, donor node, or the like, or combinations thereof. The T-TRP 102A may refer to the foregoing devices or refer to an apparatus (for example, a communication module, a modem, a chip, or the like) in the foregoing devices.

In some embodiments, the parts of the T-TRP 102A may be distributed. For example, some of the modules of the T-TRP 102A may be located remote from the equipment housing the antennas of the T-TRP 102A, and may be coupled to the equipment housing the antennas over a communication link (not shown) sometimes known as front haul, such as common public radio interface (CPRI). Therefore, in some embodiments, the term T-TRP 102A may also refer to modules on the network side that perform processing operations, such as determining the location of the UE 114, resource allocation (scheduling), message generation, and encoding/decoding, and that are not necessarily part of the equipment housing the antennas of the T-TRP 102A. The modules may also be coupled to other T-TRPs. In some embodiments, the T-TRP 102A may actually be a plurality of T-TRPs that are operating together to serve the UE 114, for example, through coordinated multipoint transmissions.

The T-TRP 102A comprises one or more circuits (such as one or more electronic circuits and/or one or more optical circuits) forming various components. For example, the T-TRP 102A may comprise at least one transmitter 144 and at least one receiver 146 coupled to one or more antennas 148. Only one antenna 148 is illustrated. One, some, or all of the antennas may alternatively be panels. The transmitter 144 and the receiver 146 may be integrated as a transceiver. The T-TRP 102A may further comprise at least one processor 142 for performing operations including those related to: preparing a transmission for DL transmission to the UE 114, processing a UL transmission received from the UE 114, preparing a transmission for backhaul transmission to NT-TRP 102B, and processing a transmission received over backhaul from the NT-TRP 102B. Processing operations related to preparing a transmission for DL or backhaul transmission may include operations such as encoding, modulating, precoding (for example, multiple input multiple output (MIMO) precoding), transmit beamforming, and generating symbols for transmission. Processing operations related to processing received transmissions in the UL or over backhaul may include operations such as receive beamforming, and demodulating and decoding received symbols. The processor 142 may also perform operations relating to network access (for example, initial access) and/or DL synchronization, such as generating the content of synchronization signal blocks (SSBs), generating the system information, and/or the like. In some embodiments, the processor 142 also generates the indication of beam direction, for example, BAI, which may be scheduled for transmission by a scheduler 154. The processor 142 performs other network-side processing operations described herein, such as determining the location of the UE 114, determining where to deploy NT-TRP 102B, and/or the like. In some embodiments, the processor 142 may generate signaling, for example, to configure one or more parameters of the UE 114 and/or one or more parameters of the NT-TRP 102B. Any signaling generated by the processor 142 is sent by the transmitter 144. Note that “signaling”, as used herein, may alternatively be called control signaling. Dynamic signaling may be transmitted in a control channel, for example, a physical downlink control channel (PDCCH), and static or semi-static higher layer signaling may be included in a packet transmitted in a data channel, for example, in a physical downlink shared channel (PDSCH), in which case the signaling may be known as higher-layer signaling, static signaling, or semi-static signaling. Higher-layer signaling may also refer to radio resource control (RRC) protocol signaling or media access control – control element (MAC-CE) signaling.

A scheduler 154 may be coupled to the processor 142. The scheduler 154 may be included within or operated separately from the T-TRP 102A, which may schedule UL, DL, and/or backhaul transmissions, including issuing scheduling grants and/or configuring scheduling-free (for example, “configured grant”) resources. The T-TRP 102A may further comprise a memory 150 for storing information and data. The memory 150 stores instructions and data used, generated, or collected by the T-TRP 102A. For example, the memory 150 may store software instructions or modules configured to implement some or all of the functionality and/or embodiments described herein and that are executed by the processor 142.

Although not illustrated, the processor 142 may form part of the transmitter 144 and/or receiver 146. Also, although not illustrated, the processor 142 may implement the scheduler 154. Although not illustrated, the memory 150 may form part of the processor 142.

The processor 142, the scheduler 154, the processing components of the transmitter 144, and the processing components of the receiver 146 may each be implemented by the same or different one or more processors that are configured to execute instructions stored in a memory, for example, in memory 150. Alternatively, some or all of the processor 142, the scheduler 154, the processing components of the transmitter 144, and the processing components of the receiver 146 may be implemented using dedicated circuitry, such as a field-programmable gate array (FPGA), a graphical processing unit (GPU), or an application-specific integrated circuit (ASIC).

Although the NT-TRP 102B is illustrated as a drone only as an example, the NT-TRP 102B may be implemented in any suitable non-terrestrial form, such as satellites and high altitude platforms, including international mobile telecommunication base stations and unmanned aerial vehicles, for example. Also, the NT-TRP 102B may be known by other names in some implementations, such as a non-terrestrial node, a non-terrestrial network device, or a non-terrestrial base station.

The NT-TRP 102B comprises one or more circuits (such as one or more electronic circuits and/or one or more optical circuits) forming various components, and may have a similar structure as the T-TRP 102A. For example, the NT-TRP 102B may comprise a transmitter 144 and a receiver 146 coupled to one or more antennas 148. Only one antenna 148 is illustrated to avoid congestion in the drawing. One, some, or all of the antennas may alternatively be panels. The transmitter 144 and the receiver 146 may be integrated as a transceiver. The NT-TRP 102B further includes at least one processor 142 for performing operations including those related to: preparing a transmission for DL transmission to the UE 114, processing an UL transmission received from the UE 114, preparing a transmission for backhaul transmission to T-TRP 102A, and processing a transmission received over backhaul from the T-TRP 102A. Processing operations related to preparing a transmission for DL or backhaul transmission may include operations such as encoding, modulating, precoding (for example, MIMO precoding), transmit beamforming, and generating symbols for transmission. Processing operations related to processing received transmissions in the UL or over backhaul may include operations such as receive beamforming, and demodulating and decoding received symbols. In some embodiments, the processor 142 implements the transmit beamforming and/or receive beamforming based on beam direction information (for example, BAI) received from T-TRP 102A. In some embodiments, the processor 142 may generate signaling, for example, to configure one or more parameters of the UE 114. In some embodiments, the NT-TRP 102B implements physical layer processing, but does not implement higher layer functions such as functions at the medium access control (MAC) or radio link control (RLC) layer. As this is only an example, more generally, the NT-TRP 102B may implement higher layer functions in addition to physical layer processing.

The NT-TRP 102B further includes a memory 150 for storing information and data. Although not illustrated, the processor 142 may form part of the transmitter 144 and/or receiver 146. Although not illustrated, the memory 150 may form part of the processor 142.

The processor 142, the processing components of the transmitter 144, and the processing components of the receiver 146 may each be implemented by the same or different one or more processors that are configured to execute instructions stored in a memory, for example, in memory 150. Alternatively, some or all of the processor 142, the processing components of the transmitter 144, and the processing components of the receiver 146 may be implemented using dedicated circuitry, such as a programmed FPGA, a hardware accelerator (for example, a GPU or artificial intelligence (AI) accelerator), or an ASIC. In some embodiments, the NT-TRP 102B may actually be a plurality of NT-TRPs that are operating together to serve the UE 114, for example, through coordinated multipoint transmissions.

The T-TRP 102A, the NT-TRP 102B, and/or the UE 114 may include other components, but these have been omitted for the sake of clarity.

The UE 114 comprises one or more circuits (such as one or more electronic circuits and/or one or more optical circuits) forming various components. More specifically, the UE 114 includes a transmitter 200 and a receiver 202 coupled to one or more antennas 204. Only one antenna 204 is illustrated to avoid congestion in the drawing. One, some, or all of the antennas may alternatively be panels. The transmitter 200 and the receiver 202 may be integrated, for example, as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The UE 114 includes at least one memory 208. The memory 208 stores instructions and data used, generated, or collected by the UE 114. For example, the memory 208 may store software instructions or modules configured to implement some or all of the functionality and/or embodiments described herein and that are executed by at least one processing unit (for example, the at least one processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The UE 114 may further include one or more input/output devices (not shown) or interfaces (such as a wired interface to the internet 108 in FIG. 1A). The input/output devices permit interaction with a user or other devices in the network. Each input/output device includes any suitable structure for providing information to or receiving information from a user, and/or for network interface communications. Suitable structures include, for example, a speaker, a microphone, a keypad, a keyboard, a display, a touch screen, a network interface, and/or the like.

The UE 114 further includes at least one processor 210 for performing operations including those operations related to preparing a transmission for UL transmission to the T-TRP 102A and/or NT-TRP 102B, those operations related to processing DL transmissions received from the T-TRP 102A and/or NT-TRP 102B, and those operations related to processing sidelink transmission to and from another UE 114. Processing operations related to preparing a transmission for UL transmission may include operations such as encoding, modulating, transmit beamforming, and generating symbols for transmission. Processing operations related to processing DL transmissions may include operations such as receive beamforming, demodulating and decoding received symbols. Depending upon the embodiment, a DL transmission may be received by the receiver 202, possibly using receive beamforming, and the processor 210 may extract signaling from the DL transmission (for example, by detecting and/or decoding the signaling). An example of signaling may be a reference signal transmitted by the T-TRP 102A and/or NT-TRP 102B. In some embodiments, the processor 142 implements the transmit beamforming and/or the receive beamforming based on the indication of beam direction, for example, beam angle information (BAI), received from T-TRP 102. In some embodiments, the processor 210 may perform operations relating to network access (for example, initial access) and/or DL synchronization, such as operations relating to detecting a synchronization sequence, decoding and obtaining the system information, and/or the like. In some embodiments, the processor 210 may perform channel estimation, for example, using a reference signal received from the T-TRP 102A and/or NT-TRP 102B.

Although not illustrated, the processor 210 may form part of the transmitter 200 and/or part of the receiver 202. Although not illustrated, the memory 208 may form part of the processor 210.

The processor 210, the processing components of the transmitter 200, and the processing components of the receiver 202 may each be implemented by the same or different one or more processors that are configured to execute instructions stored in a memory (for example, in memory 208). Alternatively, some or all of the processor 210, the processing components of the transmitter 200, and the processing components of the receiver 202 may be implemented using dedicated circuitry, such as a programmed FPGA, an ASIC, or a hardware accelerator such as a GPU or an AI accelerator.

### A-3. BASIC MODULE STRUCTURE

One or more steps of the embodiment methods provided herein may be performed by corresponding units or modules, according to FIG. 2B. FIG. 2B illustrates units or modules in a device, such as in a UE 114 or in a TRP 102. For example, a signal may be transmitted by a transmitting unit or a transmitting module. A signal may be received by a receiving unit or a receiving module. A signal may be processed by a processing unit or a processing module. Other steps may be performed by an AI or machine learning (ML) module. The respective units or modules may be implemented using hardware, one or more components or devices that execute software, or a combination thereof. For instance, one or more of the units or modules may be an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the UEs 114 and TRP 102 are known to those of skill in the art. As such, these details are omitted here.

### A-4. INTELLIGENT AIR INTERFACE

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (for example, data) over a wireless communications link. The wireless communications link may support a link between a RAN and a UE (for example, a “Uu” link), and/or the wireless communications link may support a link between device and device, such as between two user equipments (for example, a “sidelink”), and/or the wireless communications link may support a link between a non-terrestrial (NT)-communication network and a UE. The followings are some examples for the above components:

A waveform component may specify a shape and form of a signal being transmitted. Waveform options may include orthogonal multiple access waveforms and non-orthogonal multiple access waveforms. Non-limiting examples of such waveform options include orthogonal frequency division multiplexing (OFDM), filtered OFDM (f-OFDM), time windowing OFDM, filter bank multicarrier (FBMC), universal filtered multicarrier (UFMC), generalized frequency division multiplexing (GFDM), wavelet packet modulation (WPM), faster than Nyquist (FTN) waveform, Frequency-Modulated Continuous Wave (FMCW), chip waveforms and low peak to average power ratio waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: TDMA, FDMA, CDMA, SC-FDMA, low density signature multicarrier code division multiple access (LDS-MC-CDMA), non-orthogonal multiple access (NOMA), pattern division multiple access (PDMA), lattice partition multiple access (LPMA), resource spread multiple access (RSMA), and sparse code multiple access (SCMA). Furthermore, multiple access technique options may include: scheduled access vs. non-scheduled access, also known as configured grant access or grant-free access; non-orthogonal multiple access vs. orthogonal multiple access, for example, via a dedicated channel resource (for example, no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include Reed-Muller (RM) codes, turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface may not be changed or adapted once the air interface is defined. In some implementations, only limited parameters or modes of an air interface, such as a cyclic prefix (CP) length or a MIMO mode, may be configured. In some embodiments, an air interface design may provide a unified or flexible framework to support below 6 gigahertz (GHz) and beyond 6 GHz frequency (for example, mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible RAN slicing through channel resource sharing between different services in both frequency and time.

### A-5. FRAME STRUCTURE

A frame structure is a feature of the wireless communication physical layer that defines a time domain signal transmission structure, for example, to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) including subband full duplex, communication may be possible. FDD communication is when transmissions in different directions (for example, UL vs. DL) occur in different frequency bands. TDD communication is when transmissions in different directions (for example, UL vs. DL) occur over different time durations. FD communication is when transmission and reception occurs on the same time-frequency resource, that is, a device may both transmit and receive on the same frequency resource concurrently in time.

One example of a frame structure is a frame structure in long-term evolution (LTE) having the following specifications: each frame is 10 milliseconds (ms) in duration; each frame has 10 subframes, which are each one (1) ms in duration; each subframe includes two slots, each of which is 0.5 ms in duration; each slot is for transmission of seven (7) OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between UL and DL in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of one (1) ms each; a slot is defined as 14 OFDM symbols, and slot length depends upon the numerology. For example, the NR frame structure for normal CP 15 kilohertz (kHz) subcarrier spacing (“numerology 1”) and the NR frame structure for normal CP 30 kHz subcarrier spacing (“numerology 2”) are different. For 15 kHz subcarrier spacing a slot length is one (1) ms, and for 30 kHz subcarrier spacing a slot length is 0.5 ms. The NR frame structure may have more flexibility than the LTE frame structure.

Another example of a frame structure is an example flexible frame structure, for example, for use in a 6G network or later. In a flexible frame structure, a symbol block may be defined as the minimum duration of time that may be scheduled in the flexible frame structure. A symbol block may be a unit of transmission having an optional redundancy portion (for example, CP portion) and an information (for example, data) portion. An OFDM symbol is an example of a symbol block. A symbol block may alternatively be called a symbol. Embodiments of flexible frame structures include different parameters that may be configurable, for example, frame length, subframe length, symbol block length, and/or the like. A non-exhaustive list of possible configurable parameters in some embodiments of a flexible frame structure include:

(1) Frame: The frame length need not be limited to 10ms, and the frame length may be configurable and change over time. In some embodiments, each frame includes one or multiple DL synchronization channels and/or one or multiple DL broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5ms for autonomous vehicle applications. As another example, smart meters on houses may not require fast initial access, in which case the frame length may be set as 20 ms for smart meter applications.

(2) Subframe duration: A subframe might or might not be defined in the flexible frame structure, depending upon the implementation. For example, a frame may be defined to include slots, but no subframes. In frames in which a subframe is defined, for example, for time domain alignment, then the duration of the subframe may be configurable. For example, a subframe may be configured to have a length of 0.1 ms, 0.2 ms, 0.5 ms, one (1) ms, two (2) ms, five (5) ms, or the like. In some embodiments, if a subframe is not needed in a particular scenario, then the subframe length may be defined to be the same as the frame length or not defined.

(3) Slot configuration: A slot might or might not be defined in the flexible frame structure, depending upon the implementation. In frames in which a slot is defined, then the definition of a slot (for example, in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling may be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common, or UE specific.

(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, for example, if more flexible symbol durations are implemented using inverse discrete Fourier transform (IDFT) instead of fast Fourier transform (FFT). Additional examples of frame structures may be used with different SCSs.

(5) Flexible transmission duration of basic transmission unit: The basic transmission unit may be a symbol block (alternatively called a symbol), which in general includes a redundancy portion (referred to as the CP) and an information (for example, data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (for example, data) portion may be flexible and configurable. Another possible parameter relating to a symbol block that may be defined is ratio of CP duration to information (for example, data) duration. In some embodiments, the symbol block length may be adjusted according to: channel condition (for example, multi-path delay, Doppler); and/or latency requirement; and/or available time duration. As another example, a symbol block length may be adjusted to fit an available time duration in the frame.

(6) Flexible switch gap: A frame may include both a DL portion for DL transmissions from a base station, and a UL portion for UL transmissions from UEs. A gap may be present between each UL and DL portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### A-6. CELL, CARRIER, BANDWIDTH PARTS, AND OCCUPIED BANDWIDTH

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, for example, the center or lowest or highest frequency of the carrier. A carrier may be on licensed or unlicensed spectrum. Wireless communication with the device may also or instead occur over one or more bandwidth parts (BWPs) or certain subband comprising one or more Physical Resource Blocks (PRBs) or other frequency domain basic units. For example, a carrier may have one or more BWPs. More generally, wireless communication with the device may occur over spectrum. The spectrum may comprise one or more carriers and/or one or more BWPs.

A cell may include one or multiple DL resources and optionally one or multiple UL resources, or a cell may include one or multiple UL resources and optionally one or multiple DL resources, or a cell may include both one or multiple DL resources and one or multiple UL resources. As an example, a cell might only include one DL carrier/BWP, or only include one UL carrier/BWP, or include multiple DL carriers/BWPs, or include multiple UL carriers/BWPs, or include one DL carrier/BWP and one UL carrier/BWP, or include one DL carrier/BWP and multiple UL carriers/BWPs, or include multiple DL carriers/BWPs and one UL carrier/BWP, or include multiple DL carriers/BWPs and multiple UL carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, for example, a carrier may have a bandwidth of 20 megahertz (MHz) and consist of one BWP, a bandwidth of 80 MHz and consist of two adjacent contiguous BWPs, and/or the like. In other embodiments, a BWP may have one or more carriers, for example, a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmWave band, the second carrier may be in a low band (such as 2GHz band), the third carrier (if it exists) may be in terahertz (THz) band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (for example, base station) dynamically, for example, in physical layer control signaling such as downlink control information (DCI), or semi-statically, for example, in RRC signaling or in the MAC layer, or be predefined based on the application scenario; or be determined by the UE as a function of other parameters that are known by the UE, or may be fixed, for example, by a standard.

### A-7. TIMING REFERENCE POINT

In current networks, frame timing and synchronization is established based on synchronization signals, such as a primary synchronization signal (PSS) and a secondary synchronization signal (SSS). Notably, known frame timing and synchronization strategies involve adding a timestamp, for example, (xx0:yy0:zz), to a frame boundary, where xx0, yy0, zz in the timestamp may represent a time format such as hour, minute, and second, respectively.

It is anticipated that diverse applications and use cases in future networks may involve usage of different periods of frames, slots and symbols to satisfy the different requirements, functionalities and quality of service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

In some embodiments, frame timing alignment and/or realignment may comprise a timing alignment and/or realignment in terms of a boundary of a symbol, a slot or a sub-frame within a frame; or a frame (thus the frame timing alignment/realignment here is more general, not limiting to the cases where a timing alignment/realignment is from a frame boundary only). Also, relative timing to a frame or frame boundary may be interpreted in a more general sense, that is, the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In some embodiments, a network device such as a base station 102, referenced hereinafter as a TRP 102, may transmit signaling that carries a timing realignment indication message. The timing realignment indication message includes information allowing a receiving UE 114 to determine a timing reference point. On the basis of the timing reference point, transmission of frames, by the UE 114, may be aligned. In some embodiments, the frames that become aligned are in different sub-bands of one carrier frequency band. In some other embodiments, the frames that become aligned are found in neighboring carrier frequency bands.

On the TRP 102 side, one or more types of signaling may be used to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 114 of a configuration of a timing reference point. References, hereinafter, to the term “UE” may be understood to represent reference to a broad class of generic wireless communication devices within a cell (that is, a network receiving node, such as a wireless device, a sensor, a gateway, a router, or the like), that is, being served by the TRP 102. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, for example, the start of the current frame. Alternatively, the timing reference point may be expressed in terms of an absolute timing based on certain standards timing reference such as a global navigation satellite system (GNSS) (for example, global positioning system (GPS)), coordinated universal time (“UTC”), and/or the like. In the absolute timing version of the timing reference point, a timing reference point may be explicitly stated.

The timing reference point may be shown to allow for timing adjustments to be implemented at the UEs 114. The timing adjustments may be implemented for improvement of accuracy for a clock at the UE 114. Alternatively, or additionally, the timing reference point may be shown to allow for adjustments to be implemented in future transmissions made from the UEs 114. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs 114 and one or more BSs 102 (in a cell or a group of cells).

At UE 114 side, the UE 114 may monitor for the timing realignment indication message. Responsive to receiving the timing realignment indication message, the UE 114 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 114 may cause the TRP 102 to transmit the timing realignment indication message by transmitting, to the TRP 102, a request for a timing realignment, that is, a timing realignment request message. Responsive to receiving the timing realignment request message, the TRP 102 may transmit, to the UE 114, a timing realignment indication message including information on a timing reference point, thereby allowing the UE 114 to implement a timing realignment (or/and a timing adjustment including clock timing error correction), wherein the timing realignment is in terms of (for example, a starting boundary of) a symbol, a slot or a sub-frame within a frame; or a frame for UEs 114 and TRP(s) 102 in a cell (or a group of cells).

In some embodiments, a TRP 102 associated with a given cell may transmit a timing realignment indication message. The timing realignment indication message may include enough information to allow a receiver of the message to obtain a timing reference point. The timing reference point may be used, by one or more UEs 114 in the given cell, when performing a timing realignment (or/and a timing adjustment including clock timing error correction).

In some embodiments, the timing reference point may be expressed, within the timing realignment indication message, relative to a frame boundary (where a frame boundary may be a boundary of a symbol, a slot or a sub-frame with a frame; or a frame). The timing realignment indication message may include a relative timing indication, ∆t. It may be shown that the relative timing indication, ∆t, expresses the timing reference point as occurring a particular duration, that is, ∆t, subsequent to a frame boundary for a given frame. Since the frame boundary is important to allowing the UE 114 to determine the timing reference point, it is important that the UE 114 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent a SFN. When a SFN is carried by an SSB, six of the 10 bits for the SFN may be carried in a master information block (MIB) and the remaining four bits of the 10 bits for the SFN may be carried in a physical broadcast channel (PBCH) payload.

Optionally, the timing realignment indication message may include other parameters. The other parameters may, for example, include a minimum time offset. The minimum time offset may establish a duration of time preceding the timing reference point. The UE 114 may rely upon the minimum time offset as an indication that DL signaling, including the timing realignment indication message, will allow the UE 114 enough time to detect the timing realignment indication message to obtain information on the timing reference point.

### A-8. PRECODING

Precoding as used herein may refer to any coding operation(s) or modulation(s) that transform an input signal into an output signal. Precoding may be performed in different domains, and typically transform the input signal in a first domain to an output signal in a second domain. Precoding may include linear operations.

### A-9. MULTIPLE-INPUT MULTIPLE-OUTPUT (MIMO)

MIMO technology allows an antenna array of multiple antennas to perform signal transmissions and receptions to meet high transmission rate requirement. The UEs 114 and/or TRPs 102 may use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above TRP 102 configured with a large number of antennas has gained wide attentions from the academia and the industry. In the large-scale MIMO system, the TRP 102 may be generally configured with more than ten antenna units (such as antennas 148 shown in FIG. 2A), and serves for dozens of the UE 114 in the meanwhile. A large number of antenna units of the TRP 102 may greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the TRP 102 of each cell may communicate with many UEs 114 in the cell on the same time-frequency resource at the same time, thus greatly increasing the spectrum efficiency. A large number of antenna units of the TRP 102 also enable each user to have improved spatial directivity for UL and DL transmission, so that the transmitting power of the TRP 102 and/or a UE 114 is obviously reduced, and the power efficiency is greatly increased. When the antenna number of the TRP 102 is sufficiently large, random channels between each UE 114 and the TRP 102 may approach to be orthogonal, and the interference between the cell and the users and the effect of noises may be eliminated. The plurality of advantages described above enable the large-scale MIMO to have a magnificent application prospect.

A MIMO system may include a receiver connected to a receiving (Rx) antenna, a transmitter connected to transmitting (Tx) antenna, and a signal processor connected to the transmitter and the receiver. Each of the Rx antenna and the Tx antenna may include a plurality of antennas. For instance, the Rx antenna may have a uniform linear array (ULA) antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system includes:

Panel: unit of antenna group, or antenna array, or antenna sub-array which may control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, antenna port(s) identifier, channel state information reference signal (CSI-RS) resource identifier, SSB resource identifier, sounding reference signal (SRS) resource identifier, codebook indication, beam direction indication, other reference signal resource identifier, and/or the like.

### A-10. INTEGRATED TERRESTRIAL NETWORK (TN) AND NON-TERRESTRIAL NETWORK (NTN)

A terrestrial communication system may also be referred to as a land-based or ground-based communication system, although a terrestrial communication system may also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communications using 5G technology and/or later generation wireless technology (for example, 6G or later). In some examples, the terrestrial communication system may also accommodate some legacy wireless technology (for example, 3G or 4G wireless technology). The non-terrestrial communication system may be a communications using the satellite constellations like conventional geo-stationary orbit (GEO) satellites which utilize broadcast public/popular contents to a local server, low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or unmanned aerial vehicles (UAVs) (or unmanned aerial system (UAS)) achieving a dense deployment since their coverage may be limited to a local area, such as airborne, balloon, quadcopter, drones, and/or the like. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging three dimensional (3D) vertical networks consist of many moving (other than geostationary satellites) and high altitude access points such as UAVs, HAPs and VLEOs.

A-11. ARTIFICIAL INTELLIGENCE OR MACHINE LEARNING (AI/ML)

AI technologies may be applied in communication, including AI/ML based communication in the physical layer and/or AI/ML based communication in the higher layer, for example, MAC layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, for example to optimize the functionality in the MAC layer, for example intelligent TRP management, intelligent beam management, intelligent channel resource allocation, intelligent power control, intelligent spectrum utilization, intelligent modulation and coding scheme (MCS), intelligent HARQ strategy, intelligent transmit/receive (Tx/Rx) mode adaption, and/or the like.

The following are some terminologies which are used in AI/ML field:

Data collection:

Data is the very important component for AI/ML techniques. Data collection is a process of collecting data by the network nodes, management entity, or UE for the purpose of AI/ML model training, data analytics and inference.

AI/ML model training:

AI/ML model training is a process to train an AI/ML Model by learning the input/output relationship in a data driven manner and obtain the trained AI/ML Model for inference.

AI/ML model inference:

A process of using a trained AI/ML model to produce a set of outputs based on a set of inputs.

AI/ML model validation:

As a sub-process of training, validation is used to evaluate the quality of an AI/ML model using a dataset different from the one used for model training. Validation may help selecting model parameters that generalize beyond the dataset used for model training. The model parameter after training may be adjusted further by the validation process.

AI/ML model testing:

Similar with validation, testing is also a sub-process of training, and it is used to evaluate the performance of a final AI/ML model using a dataset different from the one used for model training and validation. Differently from AI/ML model validation, testing do not assume subsequent tuning of the model.

Online training:

Online training means an AI/ML training process where the model being used for inference is typically continuously trained in (near) real-time with the arrival of new training samples.

Offline training:

An AI/ML training process where the model is trained based on collected dataset, and where the trained model is later used or delivered for inference.

AI/ML model delivery/transfer:

A generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

Life cycle management (LCM):

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for sustainable operation of AI/ML in NR air-interface.

Life cycle management covers the whole procedure of AI/ML technologies which applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring may be based on inference accuracy, including metrics related to intermediate key performance indicators (KPIs), and it may also be based on system performance, including metrics related to system performance KPIs, for example, accuracy and relevance, overhead, complexity (computation and memory cost), latency (timeliness of monitoring result, from model failure to action) and power consumption. Moreover, data distribution may shift after deployment due to the environment changes, thus the model based on input or output data distribution may also be considered.

Supervised learning:

The goal of supervised learning algorithms is to train a model that maps feature vectors (inputs) to labels (output), based on the training data which includes the example feature-label pairs. The supervised learning may analyze the training data and produce an inferred function, which may be used for mapping the inference data.

Supervised learning may be further divided into two types: Classification and Regression. Classification is used when the output of the AI/ML model is categorical, that is, with two or more classes. Regression is used when the output of the AI/ML model is a real or continuous value.

Unsupervised learning:

In contrast to supervised learning where the AI/ML models learn to map the input to the target output, the unsupervised methods learn concise representations of the input data without the labelled data, which may be used for data exploration or to analyze or generate new data. One typical unsupervised learning is clustering which explores the hidden structure of input data and provide the classification results for the data.

Reinforce learning:

Reinforce learning is used to solve sequential decision-making problems. Reinforce learning is a process of training the action of intelligent agent from input (state) and a feedback signal (reward) in an environment. In reinforce learning, an intelligent agent interacts with an environment by taking an action to maximize the cumulative reward. Whenever the intelligent agent takes one action, the current state in the environment may transfer to the new state, and the new state resulted by the action will bring to the associated reward. Then the intelligent agent may take the next action based on the received reward and new state in the environment. During the training phase, the agent interacts with the environment to collect experience. The environments often mimicked by the simulator since it is expensive to directly interact with the real system. In the inference phase, the agent may use the optimal decision-making rule learned from the training phase to achieve the maximal accumulated reward.

Federated learning:

Federated learning (FL) is a machine learning technique that is used to train an AI/ML model by a central node (for example, server) and a plurality of decentralized edge nodes (for example, UEs, next Generation NodeBs, “gNBs”).

According to the wireless FL technique, a server may provide, to an edge node, a set of model parameters (for example, weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model.

Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure are performed multiple iterations until the global AI/ML model is considered to be finalized, for example, the AI/ML model is converged or the training stopping conditions are satisfied.

Notably, the wireless FL technique does not involve exchange of local data samples. Indeed, the local data samples remain at respective edge nodes.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, and/or the like. For the MAC layer, the AI communication may aim to utilize the AI capability for learning, prediction, and/or making a decision to solve a complicated optimization problem with possible better strategy and/or optimal solution, for example, to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, intelligent transmission/reception mode adaption, and/or the like.

An AI architecture may involve multiple nodes, where the multiple nodes may possibly be organized in one of two modes, that is, centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, for example, distributed machine learning and federated learning. In some embodiments, an AI architecture may comprise an intelligent controller which may perform as a single agent or a multi-agent, based on joint optimization or individual optimization. New protocols and signaling mechanisms are desired so that the corresponding interface link may be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

An air interface that uses AI as part of the implementation, for example, to optimize one or more components of the air interface, will be referred to herein as an “AI enabled air interface”. In some embodiments, there may be two types of AI operation in an AI enabled air interface: both the network and the UE implement learning; or learning is only applied by the network.

### B. SENSING IN COMMUNICATION SYSTEM

### B-1. SENSING TECHNOLOGIES

As described above, the communication system 100 or communication devices thereof often need to or prefer to understand the environment, which may be achieved via sensing.

Sensing is a technology of obtaining surrounding information, such as the information of an object including, for example, the object’s location, speed, distance, orientation, shape, texture, and/or the like. Generally, sensing may be broadly classified as:

RF sensing: Sending a RF signal and obtaining the surrounding information by receiving and processing of this RF signal or the echoed or otherwise reflected RF signal; and

Non-RF sensing: Obtaining surrounding information via means using non-RF signals such as video camera or other sensors.

RF sensing may be further classified as:

Active sensing (also denoted “device-based sensing”): A sensing device sends a RF signal to a target device. The target device detects the RF signal, obtains sensed information from the RF signal or by measuring some intermediate information thereof, and then feeds the sensed information back to the sensing device.

Passive sensing (also denoted “device-free sensing”): A sensing device sends a RF signal to an object, detects the echo of the RF signal (that is, the reflected RF signal), and obtains the sensed info from the echo.

An example of passive sensing is the radar system, wherein a sensing device may send a RF signal to localize, detect, and track a target object. A radar system is typically implemented as a standalone system for a specific application.

In passive sensing, the object such as ambient IoT devices (which are smaller and cheaper IoT devices compared to traditional IoT devices) may or may not contain certain identifier (ID) information (such as RF tags).

Generally, from the transmitter and receiver point of view, there are three types of sensing:

Monostatic sensing, wherein the transmitter and receiver are the same device;

Bi-static sensing, wherein the transmitter and receiver are different devices; for example, a TRP 102 may act as the transmitter and send the RF signals for sensing, and a UE 114 may act as the receiver and receive the RF signals;

Multi-static sensing, which may be decomposed into a plurality of bi-static Tx-Rx pairs; for example, a TRP 102 may send the RF signals for sensing, and two UEs 114 (such as UE1, UE2) may receive the RF signals, thereby forming a first Tx-Rx pair between the TRP 102 and UE1, and a second Tx-Rx pair between the TRP 102 and UE2.

### B-2. UE POSITIONING

UE position information is often used in cellular communication networks to improve various performance metrics for the network. Such performance metrics may include, for example, capacity, agility, efficiency, and/or the like. The improvement may be achieved when elements of the network exploit the position, the behavior, the mobility pattern, and/or the like, of the UE 114 in the context of a priori information describing a wireless environment in which the UE 114 is operating.

As described above, sensing system may be used to help gather UE pose information, including its location in a reference system, its velocity and direction of movement in the reference system, orientation information, the information about the wireless environment, and/or the like. For example, integrated sensing and communication may be used for determining the UE pose information. In some embodiments when integrated sensing and communication is used, the system 100 may comprise a framework for information exchange between UE 114 and the sensing system/sensing coordinator and corresponding interaction protocols.

Simultaneous localization and mapping (SLAM) can keep tracking of UE location and simultaneously constructing and/or updating an environment map (such as the communication-parameter map described below). SLAM methods will not only enable advanced cross-reality (XR) applications but also enhance the navigation of autonomous objects such as vehicles and drones. As SLAM can simultaneously obtain UE location and the environment map, it is a promising technology to realize the sensing function in integrated sensing and communication system.

SLAM can use different types of sensors for various purposes such as obtaining visual features from the environment using two dimensional (2D) and/or 3D cameras, and obtaining ranging and/or depth information using light detection and ranging (LIDAR). Radio SLAM, which has been developed more recently, is based on RF sensors (that is, radio-signal-based sensors). Although visual-based SLAM and LIDAR-based SLAM can achieve a higher resolution environment map, they may be easily affected by weather and light conditions. On the other hand, radio-based SLAM provides a lower resolution environment map, but is not affected by weather and light.

In SLAM, all processing functions for localization/positioning and environment map construction/updating are generally performed locally at the UE side. This brings great challenges to a practical implementation of SLAM because of the rather limited computing capability and power consumption of the UE 114. In addition, the locally processed SLAM does not utilize the information from other nodes in the network, for example, information from the BS or TRP 102. The resolution of the obtained environment map is usually not high.

Further terrestrial and non-terrestrial networks can enable a new range of services and applications such as earth monitoring, remote sensing, passive sensing and positioning, navigation, tracking, autonomous delivery and mobility, and/or the like. Terrestrial-networks-based sensing and non-terrestrial-networks-based sensing may provide intelligent, context-aware networks to enhance the UE experience. For example, terrestrial-networks-based sensing and non-terrestrial-networks-based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. SLAM methods will not only enable advanced cross-reality applications but also enhance the navigation of autonomous objects such as vehicles and drones. In future terrestrial and non-terrestrial networks, the measured channel data and sensing and positioning data may be obtained by large bandwidth, new spectrum, dense network, and more light-of-sight (LOS) links. Based on these data, a communication-parameter map may be drawn, where channel information is linked to its corresponding positioning or environmental information to provide an enhanced physical layer design based on this map.

The RAN 104 may provide the communication-parameter map to UE 114 for helping the UE 114 to improve its sensing function, (for example, to improve sensing accuracy or reduce sensing complexity) or assist UE communication, such as MIMO or beamforming procedures. In addition, when the location/geographical information of UE 114 changes, or the surrounding environment changes, the communication-parameter map corresponding to the UE 114 may also change. If the RAN 104 can provide the most up-to-date knowledge of communication-parameter map to UE 114 according to these changes, the processing delay or processing complexity of UE 114 may be reduced, and the performance of sensing or communication may be improved accordingly.

### C. INTEGRATED SENSING AND COMMUNICATION

### C-1. RADIO DETECTION AND RANGING (RADAR)

The term RADAR originates from the phrase radio detection and ranging; however, expressions with different forms of capitalization (that is, Radar and radar) are equally valid and now more common. Radar is typically used for detecting a presence and a location of an object. A radar system radiates radio frequency energy and receives echoes of the energy reflected from one or more targets. The system determines a given target based on the echoes returned from the given target. The radiated energy may be in the form of an energy pulse or a continuous wave, which may be expressed or defined by a particular waveform. Examples of waveforms used in radar include frequency modulated continuous wave (FMCW) and ultra-wideband (UWB) waveforms.

Radar systems may be monostatic, bi-static, or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

### C-2. INTRODUCTION

UE position information is often used in cellular communication networks to improve various performance metrics for the network. Such performance metrics may, for example, include capacity, agility, and efficiency. The improvement may be achieved when elements of the network exploit the position, the behavior, the mobility pattern, and/or the like, of the UE 114 in the context of a priori information describing a wireless environment in which the UE is operating.

A sensing system may be used to help gather UE information, including its location in a reference system (such as a global coordinate system, a local coordinate system, a reference system with respect to certain reference point(s), or the like), its velocity and direction of movement in the reference system, orientation information, the information about the wireless environment, and/or the like. Herein, the term “location” is also known as “position” and these two terms may be used interchangeably. Examples of well-known sensing systems include radio detection and ranging (RADAR) and light detection and ranging (LIDAR). While the sensing system may be separate from the communication system, it may be advantageous to gather the information using an integrated sensing and communication system, which may reduce the hardware (and cost) of the system as well as the time, frequency, or spatial resources needed to perform both sensing and communication functionalities. However, using the communication system hardware to perform sensing of an object (such as sensing the object and its position or localization, shape, orientation, gesture, and/or the like) and environment information is a highly challenging and open problem. The difficulty of the problem relates to factors such as the limited resolution of the communication system, the dynamicity of the environment, and the huge number of objects whose electromagnetic properties and positions are to be estimated.

Accordingly, integrated sensing and communication (ISAC; also known as integrated communication and sensing, joint sensing and communication, and other similar names) is a desirable feature in existing and future communication systems.

### C-3. SENSING NODE, SENSING MANAGEMENT FUNCTION

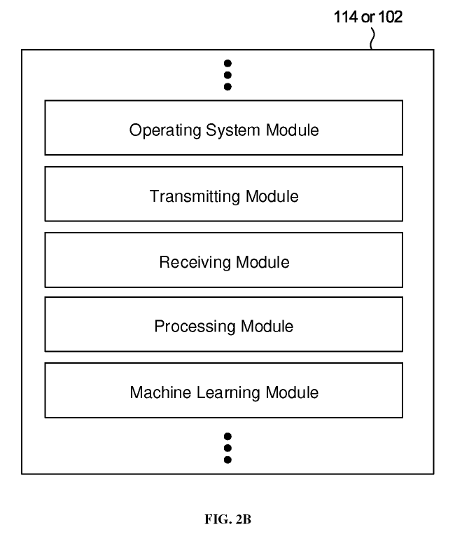

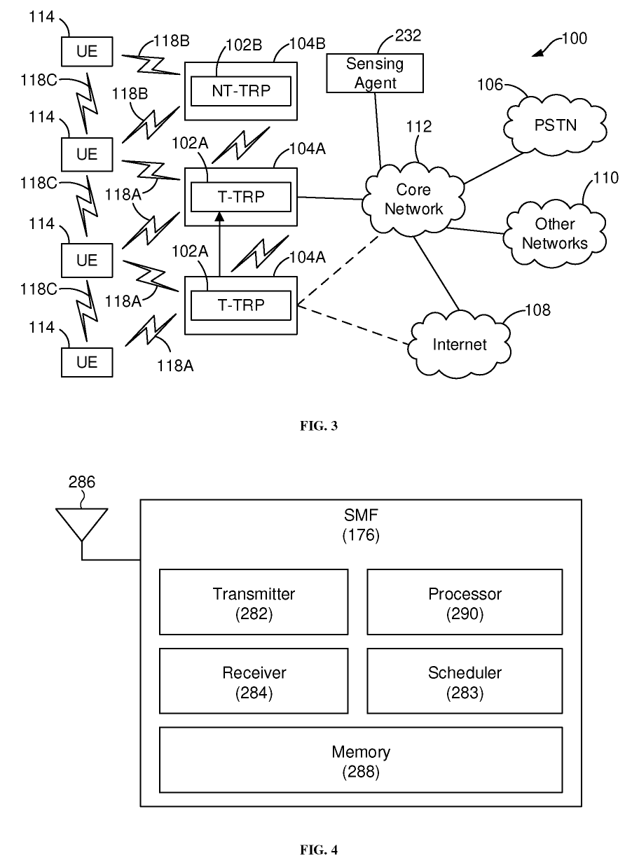

As shown in FIG. 3, any or all of the UEs 114 and TRPs 102 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent 232 is an example of a sensing node that is dedicated to sensing. Unlike the UEs 114 and TRPs 102, the sensing agent 232 does not transmit or receive communication signals. However, the sensing agent 232 may communicate configuration information, sensing information, signaling information, or other information within the communication system 100. The sensing agent 232 may be in communication with the core network 112 to communicate information with the rest of the communication system 100. By way of example, the sensing agent 232 may determine the location of the UE 114, and transmit this information to the TRP 102 via the core network 112. Although only one sensing agent 232 is shown in FIG. 3, any number of sensing agents may be implemented in the communication system 100. In some embodiments, one or more sensing agents may be implemented at one or more of the RANs 104.

A sensing node may combine sensing-based techniques with reference signal-based techniques to enhance the determination of UE-related information. This type of sensing node may also be known as a sensing management function (SMF). In some networks, the SMF may also be known as a location management function (LMF). In some embodiments, the SMF may be implemented as a physically independent entity located at the core network 112 with connection to the multiple TRPs 102. In some other embodiments, the SMF may be implemented as a logical entity co-located inside a TRP 102 through logic carried out by the processor 142.

As shown in FIG. 4, the SMF 176, when implemented as a physically independent entity, includes at least one processor 290, at least one transmitter 282, at least one receiver 284, one or more antennas 286, and at least one memory 288. A transceiver, not shown, may be used instead of the transmitter 282 and receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing, or any other functionality. The processor 290 may also be configured to implement some or all of the functionality and/or embodiments described in more detail above. Each processor 290 includes any suitable processing or computing device configured to perform one or more operations. Each processor 290 may, for example, include a microprocessor, a microcontroller, a digital signal processor, a FPGA, or an ASIC.

A reference signal-based object determination technique may involve an “active” pose estimation paradigm. In an active pose estimation paradigm, the enquirer of pose information (that is, the UE 114) takes part in process of determining the pose of the enquirer. The enquirer may transmit or receive (or both) a signal specific to pose determination process. Positioning techniques based on a GNSS such as a GPS are other examples of the active pose estimation paradigm.

In contrast, a sensing technique, based on radar for example, may be considered as involving a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques may yield enhanced object determination.

The enhanced object determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information may also facilitate sub-space based sensing to reduce sensing complexity and improve sensing accuracy.

### C-4. SENSING CHANNEL

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal, and a second set of channels may be used to transmit a communications signal. In some embodiments, each channel in the first set of channels and each channel in the second set of channels is a logical channel, a transport channel, or a physical channel.

At the physical layer, communication and sensing may be performed via separate physical channels. For example, a first physical downlink shared channel PDSCH-C is defined for data communication, while a second physical downlink shared channel PDSCH-S is defined for sensing, such as sensing data sharing for cooperative sensing, sensing reference signals, and/or the like. Similarly, separate physical uplink shared channels (PUSCHs), PUSCH-C and PUSCH-S, may be defined for UL communication and sensing. For example, PUSCH-S may be used for sensing result report and sensing data sharing.

In another example, the same PDSCH and PUSCH may be also used for both communication and sensing, with separate logical layer channels and/or transport layer channels defined for communication and sensing. Note also that control channel(s) and data channel(s) for sensing may have the same or different channel structure (format), occupy same or different frequency bands or bandwidth parts.

In a further example, a common physical downlink control channel (PDCCH) and a common physical uplink control channel (PUCCH) is used to carry control information for both sensing and communication. Alternatively, separate physical layer control channels may be used to carry separate control information for communication and sensing. For example, PUCCH-S and PUCCH-C may be used for uplink control for sensing and communication respectively, and PDCCH-S and PDCCH-C for downlink control for sensing and communication respectively.

Different combinations of shared and dedicated channels for sensing and communication, at each of the physical, transport, and logical layers, are possible.

### C-5. HALF-DUPLEX AND FULL-DUPLEX

Communication nodes may be either half-duplex or full-duplex. A half-duplex node may not both transmit and receive using the same physical resources (time, frequency, and/or the like); conversely, a full-duplex node may transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (for example, in the millimeter wave bands), and very challenging for small and low-cost devices, such as femtocell base stations 102 and UEs 114.

The limitation of half-duplex nodes in the communications network presents further challenges toward integrating sensing and communications into the devices and systems of the communications network. For example, both half-duplex and full-duplex nodes may perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

### C-6. SENSING SIGNAL WAVEFORM AND FRAME STRUCTURE

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that may be used for a sensing signal include UWB pulse, FMCW or “chirp”, OFDM, CP-OFDM, and discrete Fourier transform spread (DFT-s)-OFDM.

### D. FAST WAKEUP AND DATA TRANSMISSION METHODS AND DATA BURST STRUCTURES

In existing mobile communication systems such as 5G NR, both UE power saving and network power saving have been considered (to some extent) and discussed in, for example, the NR standard, wherein different power consumption modes (such as deep sleeping, light sleeping, micro-sleeping) with different power consumption levels may be used.

For example, in 5G NR, a UE 114 may transition between three RRC states, including the RRC_CONNECTED state, the RRC_INACTIVE state, and the RRC_IDLE state. As shown in FIG. 5, when a UE 114 powers up, it first goes through cell search and initial access to establish connection with the RAN 104, wherein the UE 114 performs a RRC connection establishment procedure to establish connection with a TRP 102 of the RAN 104 for data communication and/or making/receiving phone calls. The UE 114 is then in the RRC_CONNECTED state 302. In this state, the UE 114 may use connected mode discontinuous reception (C-DRX) to periodically monitor the physical downlink control channel (PDCCH), which allows the UE 114 to reduce some activities between two PDCCH-monitoring actions, thereby reducing the UE’s power consumption. For example, the C-DRX cycle may be configured to allow the UE 114 enter the micro sleep, light sleep, or deep sleep mode. As those skilled in the art understand, the micro sleep, light sleep, and deep sleep are defined based on the components that are switched off. For example, a UE 114 in deep sleep mode may turn off RF chain so that the UE 114 cannot monitor or receive control or data channels.

When the UE 114 has reduced activities for a period of time, the UE 114 may enter the RRC_INACTIVE state 304 by releasing the communication resources assigned thereto and suspending the RRC connection.

As specified in the third generation partnership project (3GPP), a UE 114 in the RRC_INACTIVE state 304 is generally in a dormant state wherein the UE 114 may turn off some communication-related components and operate with reduced power consumption. In the RRC_INACTIVE state 304, the non-access stratum (NAS) layer remains connected and RRC is not completely released.

A UE 114 does not perform transmission/receiving of a large amount of data in the RRC_INACTIVE state 304, which, instead, requires the UE 114 to transition to the RRC_CONNECTED state 302 by the RRC RESUME process and then performs data transmission.

The UE 114 may perform small data transmission (SDT; for example, monitor paging messages transmitted from the RAN 104 or transmit a small data packet) without transitioning to the RRC_CONNECTED state, thereby allowing the UE with reduced activities to save power. As specified in 3GPP, the UE 114 in the RRC_INACTIVE state 304 may perform SDT via random access (RA-SDT) or configured grant (CG) access (CG-SDT).

The UE 114 in the RRC_INACTIVE state 304 may transition to the RRC_CONNECTED state 302 by resuming the RRC connection.

When the UE 114 in the RRC_INACTIVE state 304 has no activity for a prolonged period of time, the UE 114 may release the RRC connection and enter the RRC_IDLE state 306 to have reduced paging detection and measurement frequency, thereby further reducing its power consumption. The UE 114 may transition to the RRC_CONNECTED state 302 by re-establishing the RRC connection. A UE 114 in the RRC_CONNECTED state 302 may also directly enter the RRC_IDLE state 306 after a prolonged period of time with no activity, by releasing the RRC connection.

In older mobile communication standards such as LTE, a UE 114 may only transition between the RRC_CONNECTED state 302 and the RRC_IDLE state 306 (that is, no RRC_INACTIVE state 304).

Wakeup signals (WUS) may be used to wake up a UE 114 in the RRC_INACTIVE state 304 or the RRC_IDLE state 306 to transition to the RRC_CONNECTED state 302. However, the WUS used in existing mobile communication systems may cause different wakeup time for different RRC states. Moreover, to wake up a UE 114 and start data transmission, many steps are needed in conventional methods which introduce additional activities such as:

system re-entry (such as re-synchronization, system information update, and the like) for UE 114 in the RRC_INACTIVE state 304 or the RRC_IDLE state 306, and for UE 114 with long sleeping time;

state transition for UE 114 in the RRC_INACTIVE state 304 or the RRC_IDLE state 306;

channel acquisition or channel measurements for MIMO and/or beamforming (BF);

channel quality indicator (CQI) measurement and feedback for link adaption; and

RRC configuration update.

The introduced additional activities may cause significant power consumption.

According to one aspect of this disclosure, a fast wakeup and data transmission method (also called a “one-shot self-contained data transmission method” or simply a “one-shot data transmission method”) is disclosed. The fast wakeup and data transmission method uses a fast data-burst transmission method to transmit from a UE 114 to a TRP 102 (or from a TRP 102 to a UE 114) a data burst arranged in accordance with a one-shot data-burst structure, for providing a single-step wakeup and communication mechanism (also denoted “wakeup & go”). In various embodiments, a method for initial MCS and other transmission parameter determination, a progressive precoding and/or BF adaption method, and a progressive link adaption method may also be used for fast wakeup.

Herein, the fast wakeup and data transmission method is a simplified process performed by a TRP 102 and a UE 114 with at least one of the TRP 102 and UE 114 in a status with restricted or reduced power consumption in wireless communication related activities; such as in a sleep state with a restricted or reduced wireless communication capability for “wake up and go” (described later).

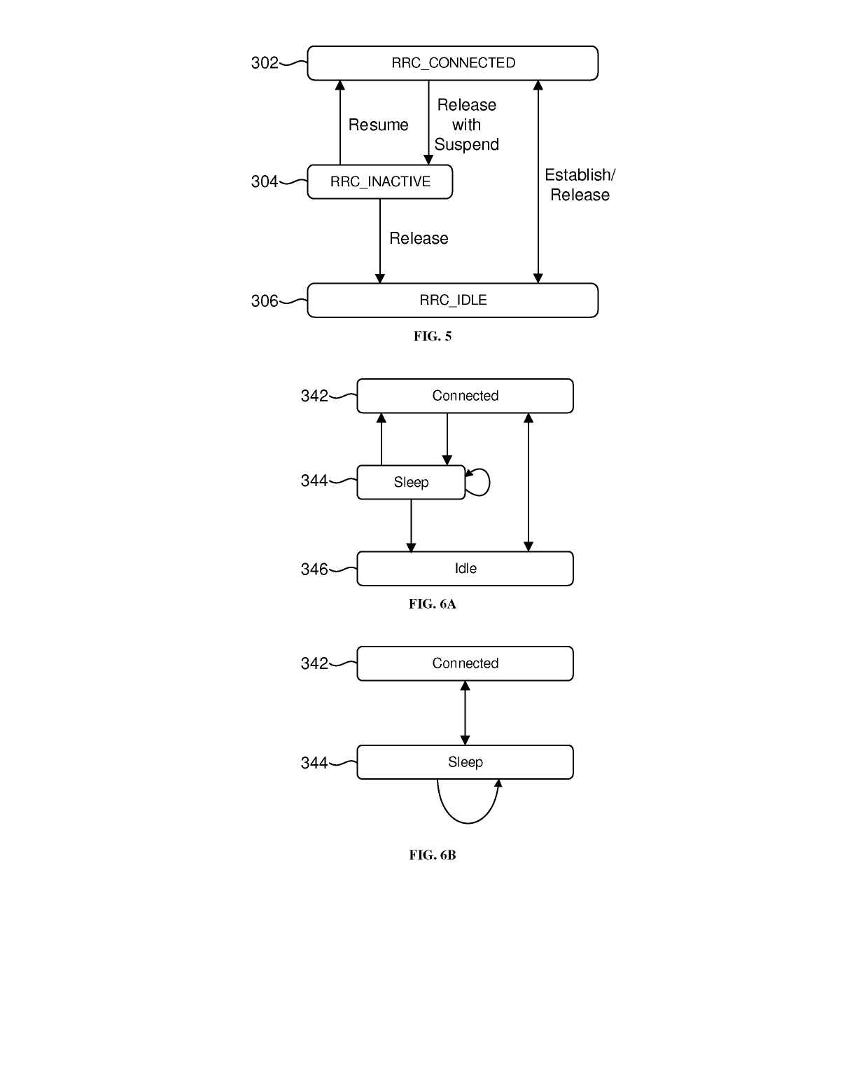

FIG. 6A shows the states of a device (such as a UE 114 or a TRP 102) according to some embodiments of this disclosure. As shown, the device may transition between a connected state 342 (which is similar to the RRC_CONNECTED state 302), a low power-consumption state or sleep state 344, and an idle state 346 (which may be similar to the RRC_IDLE state 306 although the device may enter the idle state 346 after an extended period of time of inactivity longer than the period of time of inactivity for entering the RRC_IDLE state 306). The transition between the connected state 342 and the idle state 346 is similar to that between the RRC_CONNECTED state 302 and the RRC_IDLE state 306.

In these embodiments, the sleep state 344 is an operation state or mode when one or more components of the device are switched off for energy saving. The device in the sleep state generally has significantly reduced activities, and its ability to transmitting and receiving signal, and measuring or sounding the communication channel and/or sensing the environment is also significantly reduced. Different level of sleeping turns off different components or applies low capability components, for example power amplifiers (PAs), low noise amplifier (LNAs), integrated circuits (ICs) in transmitter and receiver units, and/or the like. In some embodiments, it may be preferable to turns off as many circuitry components as possible and keeps only a few components on for maintain internal clocks and transmission/reception of necessary signals (such as LCM signals) to keep the device “alive”.

As will be described in more detail later, when the TRP 102 and/or UE 114 is in the sleep state 344, the TRP 102 and/or UE 114 may use the fast wakeup and data transmission method for rapid transmission therebetween one or more wakeup signals to wake up the “sleeping” device (that is, the TRP 102 and/or UE 114 in the sleep state), and performing data transmission therebetween before the sleeping device transitions to the connected state.

The data transmission therebetween may comprise one or more data sets, each data set comprising one or more data fields, and may be transmitted from the TRP 102 to the UE 114 (that is, DL data transmission), or from the UE 114 to the TRP 102.

For example, the TRP 102 may transmit a fast-wakeup signal and then one or more data sets to the UE 114 in the sleep state. The fast-wakeup signal comprises control information such as the time-frequency resources for the subsequent data transmission. The UE 114 uses the control information in the fast-wakeup signal and also use information (such as MIMO-related information, initial MCS, and/or the like) stored before the UE 114 entered the sleep state, to receive the data transmitted from the TRP 102 without transitioning to the connected state. The UE 114 may send an acknowledgement (ACK) to the TRP 102 indicating successful data receiving, or a negative-acknowledgement (NACK) to the TRP 102 indicating unsuccessful data receiving so that the TRP 102 may retransmit the data.

After data receiving, the UE 114 may enter an increased, less restricted, unrestricted, or even full power consumption status (with respect to wireless communication related activities) with increased or even full wireless communication capability (such as transitioning to the connected state), or may go back to sleep (that is, remaining in the sleep state) after receiving a release indication or after a predefined or preconfigured timing expires.

As another example, the UE 114 may send a wakeup preamble (functioning as a wakeup signal) to wake up the TRP 102 in the sleep state. The UE 114 then sends to the TRP 102 one or more data sets using grant-free (GF; also called “configured grant”) transmission (that is, using time-frequency resource reserved before the TRP 102 entered the sleep state. The UE 114 may wait for the ACK/NACK feedback from the TRP 102 to decide whether data retransmission is needed. Alternatively, the UE 114 may go back to sleep without waiting for the ACK/NACK feedback.

As yet another example, the UE 114 in the sleep state may send a wakeup preamble to the TRP 102 to indicate its waking up, and then sends to the TRP 102 one or more data sets using grant-free (GF) transmission (that is, using time-frequency resource reserved before the TRP 102 entered the sleep state). The UE 114 may wait for the ACK/NACK feedback from the TRP 102 to decide whether data retransmission is needed. Alternatively, the UE 114 may go back to sleep after the data-set transmission is finished without waiting for the ACK/NACK feedback.

In some embodiments, the TRP 102 may send a fast-wakeup signal and then some data to the UE 114 as described above. The UE 114 may receive the data without transitioning to the connected state, and also send some data to the TRP 102 using GF transmission at the same time, thereby achieving full duplex (FD) or subband FD. Alternatively, while the UE 114 is receiving the DL data from the TRP 102, the UE may also receive one or more updated transmission parameters from the DCI transmitted from the TRP 102, and use the updated transmission parameters to send some data to the TRP 102 (that is, in granted mode) at the same time for achieving full duplex (FD) or subband FD. The DCI may comprise updated transmission parameters such that the UE may continue data transmission/reception with new parameters.

Similarly, the UE 114 may send a preamble and then some data to the TRP 102 using GF transmission as described above. The TRP 102 may receive the data without transitioning to the connected state, and also send some data to the UE 114 at the same time, thereby achieving full duplex (FD) or subband FD.

In some embodiments, the device (such as the UE 114) in the sleep state may perform some (such as minimum) communication-related measurements (such as channel measurements) based on the wakeup signal (for example, the reference signals (RS; such as CSI-RS, demodulation reference signal (DMRS), and/or the like) embedded in the wakeup signal). As those skilled in the art will appreciate, complete channel measurements usually require a significant amount of time, especially for MIMO with a large number of antennas. Thus, in these embodiments, the communication-related measurements performed by the device in the sleep state may be fast, partial (or incomplete) communication-related measurements (that is, only measuring a subset of one or more communication-related parameters) in order to reduce the overhead and/or the power consumption. The communication-related measurements may be fed back to the other side (such as the TRP 102) using a soft ACK/NACK. Herein a soft ACK/NACK refers to a multi-bit feedback wherein the payload thereof comprises an ACK or NACK reporting (that is, being ACK or NACK depending on the success or failure of a message reception/decoding) and channel information such as channel state information (CSI).

Alternatively or in addition, the device in the sleep state may perform the communication-related measurements based on the RS embedded in the first data set, and send the communication-related measurements to the other side so as to progressively adapt to the channel (that is, progressive link adaption) so that the subsequent data transmission/receiving may use the updated communication-related parameters for improved performance. Similarly, the device in the sleep state may also perform the communication-related measurements based on the RS embedded in subsequent data sets, thereby gradually or progressively adapting to the link between the TRP 102 and UE 114.

Moreover, as will be described in more detail later, in some embodiments, the LCM signal transmitted between the TRP 102 and UE 114 may also be used for communication-related measurements, thereby enabling progressive link adaption throughout the sleep state.

As those skilled in the art will appreciate, the sleep state 344 may be similar to the RRC_INACTIVE state 304 or the RRC_IDLE state 306 in terms of how the device may enter this state (such as inactivity for a period of time), and how the device in this state may switch off one or more components for energy saving. However, the sleep state 344 is different to the RRC_INACTIVE state 304 or the RRC_IDLE state 306 in many aspects such as how the device reduces the Tx/Rx capability or turns off Tx/Rx functions and components, how the device transmits and/or receives necessary signals (such as LCM signals) to keep itself “alive”, how the device maintains information for fast wakeup, and how the device reacts to a fast-wakeup signal and immediately receives/transmits data.

In some embodiments as shown in FIG. 6B, the device may only transition from the connected state 342 to the sleep state 344 (that is, no idle state 346).

For the purpose of fast wakeup, the UE 114 and/or TRP 102 may store necessary information when entering the sleep state 344. For example, in some embodiments, the UE 114 may store necessary communication-related information that may be used for fast wakeup, such as UE connection ID, one or more predefined communication parameters for initial control and data transmission and reception such as MIMO configuration, MCS setting, neighboring TRP-related information, one or more power control parameters, and/or the like.

Thus, when waking up, the UE 114 and/or TRP 102 may immediately start data transmission using the stored communication-related information without the requirement of a channel measurement period for obtaining the current channel status and other related settings and/or parameters (such as without obtaining the current channel measurements, MIMO optimization, link adaption, and/or the like). Such stored communication-related information may be position-related, and may be obtained in various way.

Those skilled in the art will appreciate that, the communication-related information may be obtained via any suitable methods such as based on historical RF signal measurements performed by one or more UEs, via sensing such as environment sensing, integrated sensing and communication, SLAM, surveying, and/or the like. For example, as described above, the TRPs 102 (or the RAN 104) may collect and use their own communication-related information (such as channel and/or sensing data), and/or collect and use communication-related information from UE 114. The TRPs 102 and/or the UEs 114 may also track the positions of the UEs 114. Therefore, the TRPs 102 (or the RAN 104) may use the collected communication-related information (such as measured channel data and sensing and positioning data) to build and repeatedly update a higher-resolution communication-parameter map (also called a “RF map”) of a site or an area, where channel information is linked to its corresponding positioning or environmental information to provide an enhanced physical layer design based on this map.

The TRPs 102 may repeatedly (such as periodically or when needed) send to UEs 114, or at least send to UEs 114 before they enter the sleep state, the communication-parameter map or a portion thereof around the current location of each UE 114, the communication-parameter map or a portion thereof around the current location of each UE 114.

The UE 114 stores the received communication-parameter map or the portion thereof for later fast wakeup. Generally, when a UE 114 is waking up, the UE 114 has limited prior-channel knowledge. Thus, the UE 114 may obtain the communication-related information around its current location from its stored communication-parameter map or the portion thereof so as to immediately transmit or receive data to or from the TRP 102. In the following, the UE’s stored communication-parameter map or the portion thereof are collectively denoted the UE’s communication-parameter map for ease of description.

As shown in FIG. 7, a communication-parameter map 372 is related to a geographic map 362 of a site or an area.

Herein, the term “communication-parameter map” represents communication-related information such as radio environment information, and may also be referred to as a radio environmental map, a radio frequency (RF) map, a radio map, a radio-based map, a radio-signal-based map, a wireless-signal-based map, or other maps with similar meanings, and all of these similar-meaning terms may be used interchangeably in this disclosure.

Herein, the term “geographic map” used herein represents geography and/or geometry information, and may also be referred to as location/geometry/geographic information or map (G-map), or some intermediate results after processing of location/geometry/geography information, or other maps with similar meanings. In this disclosure, the terms “geographic map” and “G-map” may be used interchangeably.

Moreover, the term “map” used herein represents a form of indication, and can also be replaced by other names such as list, matrix, group, set, range, area, relationship, lookup table, information, and/or the like. The term “mapping” represents a relationship, and can also be replaced by other names such as relationship, matching, lookup table, and/or the like.

A further description of such terms and the details of such maps can be found in PCT International Application Serial No. PCT/CN2023/130336, entitled “METHOD, APPARATUS, AND SYSTEM FOR MAPPING BETWEEN RADIO ENVIRONMENT INFORMATION AND GEOMETRY INFORMATION”, filed on November 08, 2023, the content of which is incorporated herein by reference in its entirety.

The geographic map 362 is partitioned into one or more subareas or zones 364. Each zone 364 comprises necessary geographic information such as 2D and/or 3D location of the zone 364, surrounding geometric information of the zone 364, geometric indication of the zone 364 with respect to a reference point, preprocessed geometry or geography, and/or the like.

The communication-parameter map 372 comprises one or more entries 374 (also called “blocks” or “elements”) with each entry 374 related to one or more zones 364 having similar communication-related information such as ray tracing or multi-path information, channel information, beamforming information (for example, absolute beam angle, relative beam angle, beam gradient, beam width, and/or the like) of one or multiple beams, one or more MIMO parameters, long-term MCS, path loss, one or more long-term power-control parameters, and/or the like, and stores such communication-related information for the related one or more zones 364. Thus, when an entry of the communication-parameter map 372 (such as the entry 374A in FIG. 7) is related to multiple zones of the geographic map 362 (such as zones 364A and 364B in FIG. 7), the multiple zones 364A and 364B have similar communication-related information. Moreover, although the geographic map 362 and the zones 364 shown in FIG. 7 are in rectangular shapes, in various embodiments, the geographic map 362 and the zones 364 thereof may be in any suitable shapes (which may be regular shapes and/or irregular shapes) and/or in any suitable forms. Similarly, the communication-parameter map 372 may also be in any suitable shapes and/or in any suitable forms such as a list, a lookup table, an array, a matrix, a 2D or 3D map, and/or the like.

Each entry 374 of the communication-parameter map 372 may store the communication-related information for the related one or more zones 364 without storing the geographic information of the related one or more zones 364, in which case the UE 114 may need to store both the geographic map 362 and the communication-parameter map 372 (or a portion of the two maps around the UE’s current position).

Alternatively or additionally, each entry 374 of the communication-parameter map 372 may store the geographic information of the related one or more zones 364 and the communication-related information therefor, in which case the UE 114 may only store the communication-parameter map 372 or a portion thereof, and may not need to store the geographic map 362.

When the UE 114 and /or TRP 102 is in the sleep state 344, a lifecycle management (LCM) signal may be repeatedly (such as periodically and/or as needed) transmitted between the TRP 102 and the UE 114 for tracking the location of the UE 114, maintaining basic synchronization between the UE 114 and the TRP 102, and/or the like, so as to keep the UE 114 “alive”. In some embodiments, the LCM signal may also be used for performing measurements (such as channel measurements, sensing measurements, and/or the like) which may be updated to the communication-parameter map stored at the TRP and/or UE side.

In some embodiments, the LCM signal may be generated based on separated low-power (that is, reduced power) transmission and/or receiving, with predefined or customizable monitoring period. For example, the LCM signal may be generated with simplicity in such a way that it may be suitable for being handled by dedicated low-power and/or low-cost receiver and possibly different transmitter (which would be different to and computationally less powerful than the receiver and transmitter used for normal communication (control and data)). Thus, it is generally preferable that the LCM signal is a low-power signal relatively simple for detection and for communication-related measurements. Examples of such a LCM signal may be an on-off keying (OOK) signal, a frequency-shift keying (FSK) signal, a phase-shift keying (PSK) signal, a chirp or frequency modulated continuous wave (FMCW) signal, a passive signal, or the like.

In some embodiments, a LCM signal may be transmitted from the TRP 102 to the UE 114 (denoted “DL LCM”) for the UE 114 to perform measurements such as channel measurements, sensing measurements, location or position tracking, time and/or frequency synchronization, phase noise tracking, and/or the like. In some embodiments, the UE 114 may respond to the LCM by feeding back the measurement results to the TRP 102 for the TRP 102 to perform environment sensing update. In some other embodiments, the UE 114 may not respond to the LCM.

A LCM signal may alternatively or additionally be transmitted from the UE 114 to the TRP 102 (denoted “UL LCM”) for the TRP 102 to perform measurements (such as channel measurements, sensing measurements, and/or the like), location or position tracking, one or more time advance measurements for maintaining UL synchronization, and/or the like. In some embodiments, the TRP 102 may respond to the LCM by sending the measurement results to the UE 114 for the UE 114 to perform environment sensing update. In some other embodiments, the TRP 102 may not respond to the LCM.

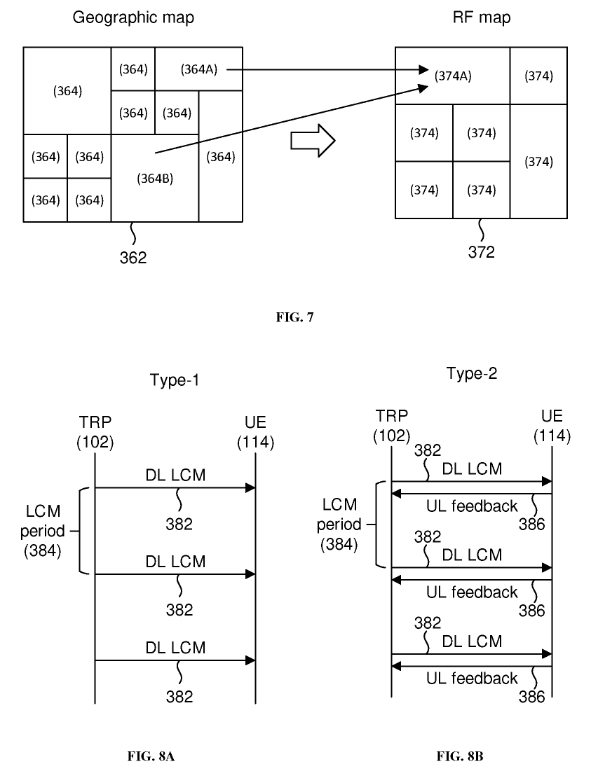

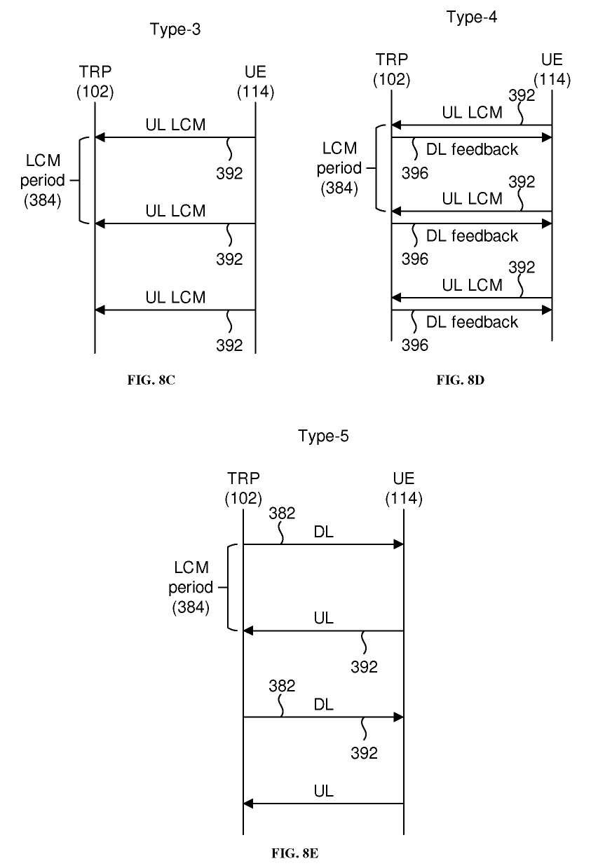

FIGS. 8A to 8E show some examples of the use of LCM signals (which may be configured according to requirements such as expected DL or UL traffic, power saving, carrier frequency range, and/or the like).

In some embodiments as shown in FIG. 8A, the TRP 102 periodically transmits DL LCM signals 382 to the UE 114, wherein the LCM transmission period 384 is defined as the length of time between two successive DL LCM transmissions. In these embodiments, the UE 114 does not respond to the DL LCM signals.

In some embodiments as shown in FIG. 8B, the TRP 102 periodically transmits DL LCM signals 382 to the UE 114, wherein the LCM transmission period 384 is defined as the length of time between two successive DL LCM transmissions. In these embodiments, the UE 114 responds to each DL LCM signal 382 by sending a UL feedback 386 as described above. The gap or time difference between the transmission of the DL LCM signal 382 and the transmission of the UL feedback 386 may be a predefined time difference or a customizable time difference such as an absolute time difference, a time difference related to a reference point such as DL/UL switch point, or the like.

In some embodiments as shown in FIG. 8C, the UE 114 periodically transmits UL LCM signals 392 to the TRP 102, wherein the LCM transmission period 384 is defined as the length of time between two successive UL LCM transmissions. In these embodiments, the TRP 102 does not respond to the UL LCM signals.

In some embodiments as shown in FIG. 8D, the UE 114 periodically transmits UL LCM signals 392 to the TRP 102, wherein the LCM transmission period 384 is defined as the length of time between two successive UL LCM transmissions. In these embodiments, the TRP 102 responds to each UL LCM signal 392 by sending a DL feedback 396 as described above. The gap or time difference between the transmission of the UL LCM signal 392 and the transmission of the DL feedback 396 may be a predefined time difference or a customizable time difference such as an absolute time difference, a time difference related to a reference point such as DL/UL switch point, or the like.

In some embodiments as shown in FIG. 8E, the TRP 102 and UE 114 periodically and alternately transmit DL and UL LCM signals 382 and 392 to each other, wherein the LCM transmission period 384 is defined as the length of time between a DL LCM transmission and the subsequent UL LCM transmission. In these embodiments, the TRP 102 and UE 114 do not respond to their received LCM signals.

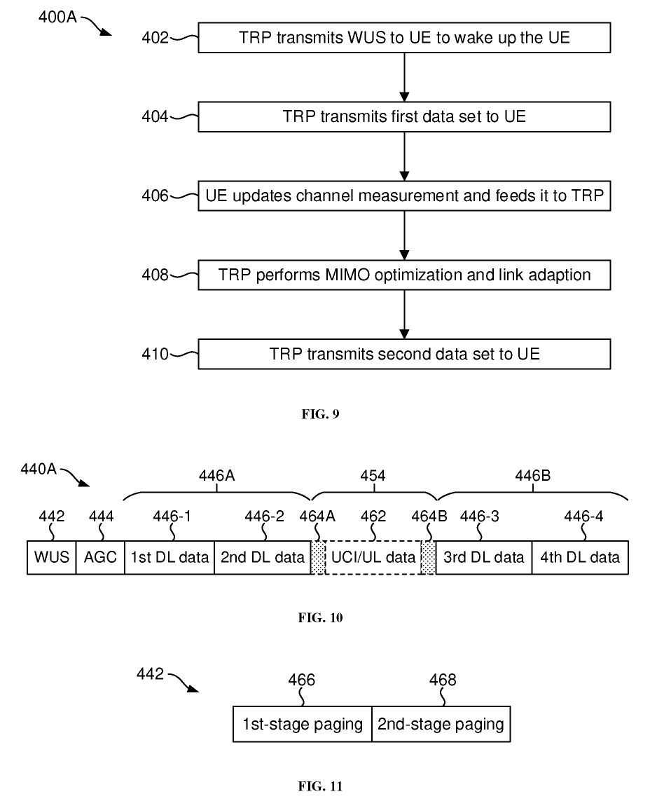

FIG. 9 is a flowchart showing the steps of a fast wakeup and data transmission method 400A performed by a TRP 102 and a UE 114 to wake up the UE 114 in the sleep state 344, and transmit one or more DL data sets from the TRP 102 to the UE 114 (that is, DL data transmission) without state transition, according to some embodiments of this disclosure.

At step 402, the UE 114 is woken up by, for example, a fast-wakeup signal sent from the TRP 102 to the UE 114. The fast-wakeup signal provides different wakeup time budgets, for example, depend on different sleeping lengths. In these embodiments, the fast-wakeup signal carries control information such as an indication of the time-frequency resource for transmission of a first data set. The fast-wakeup signal may also carry additional information such as timing indication, and one or more initial transmission parameters such as MCS, quasi co-located (QCLed) beamforming, one or more QoS related parameters (for example, one or more latency requirements, one or more reliability requirements, and/or the like), and/or the like. Those skilled in the art will appreciate that, in some embodiments, such additional information may be stored in the communication-parameter map, and thus the fast-wakeup signal does not need to carry the additional information.

At step 404, a first DL data set having one or more DL data fields is transmitted from the TRP 102 to the UE 114. The first DL data set is organized in accordance with a self-contained data-burst structure, which comprises a self-contained multi-purpose reference signal (RS; such as CSI-RS, demodulation reference signal (DMRS), or the like) for channel estimation, channel acquisition, phase noise compensation, time and frequency synchronization, and/or the like.

In some embodiments, the transmission of the first DL data set is in accordance with the control information in the fast-wakeup signal and the communication-parameter map (such as using an initial BF/MIMO configuration, an initial MCS, and an initial power control in accordance with the information in the fast-wakeup signal and the communication-parameter map).

At step 406, the UE 114 uses the information retrieved from the fast-wakeup signal and the communication-parameter map to receive the first DL data set (that is, no separate RS transmission period and thus no channel measurement updates after the fast-wakeup signal and before first data transmission), and performs channel measurements based on the received first data set. For example, channel state information (CSI) may be updated based on the received first data set (or the RS therein), the DMRS, the decoded data, the new environment/channel sensing results, and/or the like. The updated channel measurements are fed back to the TRP 102.

At step 408, the TRP 102 uses the updated channel measurements for optimizing the connection between the UE 114 and TRP 102 such as BF optimization, MIMO optimization, link adaption, and/or the like for subsequent data transmission such as transmission of a second data set. Those skilled in the art will appreciate that the “optimization” at this step is based on the updated channel measurements and does not necessarily achieve the optimized results that maximize the data transmission performance (which will be ultimately achieved in the connected state). However, such a “limited” optimization may be repeated with subsequent data transmissions to achieve progressive link adaption.

For example, in the BF and/or MIMO optimization, the MCS may be adjusted based on the updated channel measurements for subsequent data transmission. Moreover, the BF and/or MIMO optimization may be based on the updated channel measurements, new environment and/or channel sensing results, required data rate, power saving requirements, and/or the like.

At step 410, the TRP 102 sends the optimized one or more communication parameters obtained at step 408 to the UE 114 and uses the optimized communication parameters for second data transmission to the UE 114. Accordingly, the UE 114 transitions to the connected state 342 and receives the second data transmission from the TRP 102.

Thus, the fast wakeup and data transmission method 400A provides a method for immediate communication after wakeup to achieve “arrive and go” (that is, immediate data transmission after arrival of the fast-wakeup signal) without state transition (that is, before transiting from the sleep state 344 to the connected state 342).

Those skilled in the art will appreciate that, in some embodiments, steps 406 to 410 may not be performed. In other words, the UE 114 may go back to “sleep” after receiving the first data set.

In some embodiments, step 410 may not be performed. In other words, after receiving the first data set, the UE 114 may update channel measurement and feeds it to TRP, and then go back to “sleep”. The TRP 102 may perform step 408 for MIMO optimization and link adaption but would not perform step 410 to transmit any more data sets.

FIG. 10 shows the structure of the DL data burst 440A transmitted from the TRP 102 to the UE 114 in the fast wakeup and data transmission method 400A, according to some embodiments of this disclosure. As shown, the DL data burst 440A comprises a plurality of fields such as a fast-wakeup signal 442, an optional automatic gain control (AGC) head 444, and one or more DL data fields 446 (each may comprise one or more RS), each may take one or more basic time-domain scheduling units such as one or more slots, one or more sub-slots, or one or more symbols. As will be described in more detail later, the one or more DL data fields 446 may be partitioned into a first data set 446A and a second data set 446B transmitted using different parameters.

In these embodiments, the fast-wakeup signal 442 is in a simplified DCI format (for example, with less fields or bits compared to DCI of regular scheduling, which may be feasible because the fast-wakeup signal 442 is used to schedule initial transmission with estimated channel condition and because of reduced transmission capabilities such as MIMO, bandwidth, MCS, and/or the like), and may be considered as a scheduling request signal. In some embodiments, the fast-wakeup signal 442 comprises an indication of the time-frequency resource assigned for the first DL data set 446A.

As shown in FIG. 11, in some embodiments, the fast-wakeup signal 442 may be a two-stage fast-wakeup signal including a first-stage WUS 466 such as a first-stage paging signal for waking up the receiving device (such as the UE 114) and a second-stage WUS 468 such as a second-stage paging signal for scheduling the transmission of the one or more DL data fields 446.

More specifically, the second-stage WUS 468 may comprise the indication of time-frequency resource, the initial BF and/or MIMO information, initial MCS, HARQ, and/or the like for the transmission of the first data set 446A. For example, the second-stage WUS 468 may comprise simplified DCI (including the total number of one or more slots and/or the indices of one or more slots, bandwidth, carrier index or indication, and/or the like), or may comprise information related to a subsequent PDCCH (which comprises the simplified DCI indicating the time-frequency resource for the transmission of the first data set 446A).

Optionally, the second-stage WUS 468 may also comprise indication of positioning reference signal (PRS), CSI-RS, and/or other measurement reference signal configurations. Such measurement reference signal configurations may be used for channel measurements which are fed back to the TRP 102 after the first data transmission (such as the first data set 446A shown in FIG. 10; described in more detail later) so that the TRP 102 may update one or more communication-related parameters for use in subsequent data transmission (such as the second data set 446B shown in FIG. 10) with improved performance.

Optionally, the second-stage WUS 468 may further comprise an absolute timing reference.

The use of the two-stage fast-wakeup signal may further reduce wakeup signal detection power consumption because the second-stage WUS 468 may only be performed once the first-stage WUS 466 is successfully detected. Since the first-stage WUS 466 does not contain control information, it may simply be, for example, a sequence or other types of signatures. Of course, in some embodiments, the fast-wakeup signal 442 may be a single-stage WUS containing, for example, above-described control information and the UE ID.

The AGC head 444 allows the UE 114 to adjust dynamical range of the received power. The AGC head 444 is optional, meaning that, in some embodiments, the data burst 440A may not comprise the AGC head 444.

The fast-wakeup signal 442 and the optional AGC head 444 are transmitted at step 402 (although the AGC head 444 may alternatively be considered as transmitted at step 404).

In some embodiments when the data burst 440A comprises a plurality of DL data fields 446 (such as DL data fields 446-1 to 446-4 shown in FIG. 10), the DL data fields 446 may be partitioned into, for example, a first DL data set 446A of one or more DL data fields 446-1 and 446-2 (transmitted at step 404), and a second DL data set 446B of one or more DL data fields 446-3 and 446-4 (transmitted at step 410). The first DL data set 446A and the second DL data set 446B are separated in time by a time period 454 for the UE 114 to transmit to the TRP 102 a UL feedback comprising uplink control information (UCI) and/or UL data 462 (represented using dotted line). A time gap 464 (denoted a “DL/UL switch gap”) may be maintained between neighboring data set and the UCI/UL data 462, such as a time gap 464A between the first DL data set 446A and the UCI/UL data 462, and a time gap 464B between the UCI/UL data 462 and the second DL data set 446B, for reducing or eliminating interference. The time gaps 464 may be configured based on for example the switching time required by device, propagation delay, and/or the like.

In some embodiments, the fast-wakeup signal 442 and the AGC head 444 may be separated in time by a predefined or customized time gap. In some embodiments, the AGC head 444 and the first DL data field 446-1 may be separated in time by a predefined or customized time gap. In some embodiments wherein the AGC head 444 is not used, the fast-wakeup signal 442 and the first DL data field 446-1 may be separated in time by a predefined or pre-configured time gap.

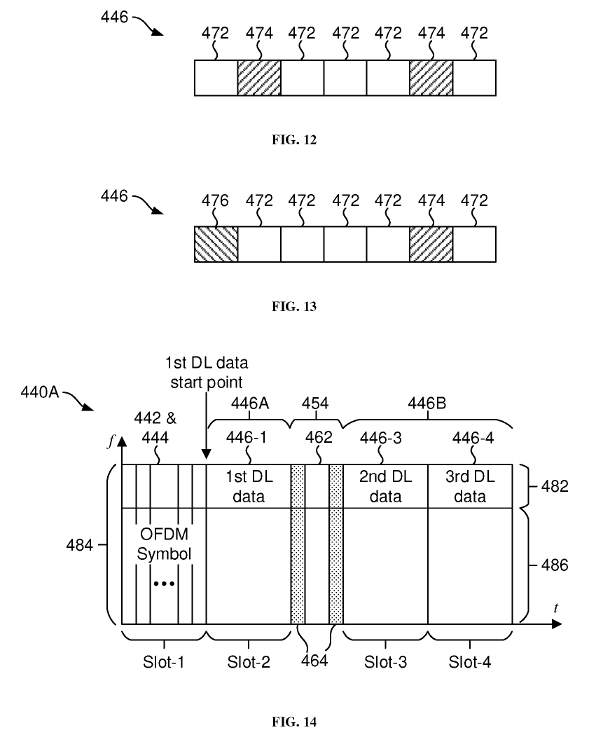

As shown in FIG. 12, each DL data field 446 may comprise one or more data symbols 472 and one or more RS symbols 474, wherein the one or more RS symbols 474 may comprise any suitable RS such as DMRS, phase tracking reference signal (PTRS), channel state information reference signal (CSI-RS), and/or the like. Moreover, the one or more RS symbols 474 may be in any suitable locations in the DL data field 446 such as in dedicated symbol locations or multiplexed with the data symbols 472 in a same OFDM symbol.

As shown in FIG. 13, in some embodiments, a DL data field 446 may comprise one or more data symbols 472, one or more RS symbols 474, and one or more DCI subfields 476.

FIG. 14 shows an example for illustrating the location and boundary alignment of a data burst 440A in the time-frequency plane. More specifically, the data burst 440A in this example only comprises three DL data fields 446-1, 446-3, and 446-4, wherein the first DL data set 446A comprises the DL data field 446-1, and the second DL data set 446B comprises the DL data fields 446-3 and 446-4. The fast-wakeup signal 442 and the AGC head 444 are transmitted in slot-1 (as part of an OFDM symbol), the first DL data field 446-1 is transmitted in slot-2 which is followed by the UCI/UL data 462 (and the gaps 464 therebefore and thereafter), the second DL data field 446-3 is transmitted in slot-3 after the UCI/UL data 462, and the third DL data field 446-4 is transmitted in slot-4. In this example, the data burst 440A may only occupy a portion of the time-frequency resources, that is, a portion 482 of the frequency band 484. The other portion 486 of the frequency band 484 may be used for transmitting the data bursts 440A for one or more other UEs 114.

In these embodiments, different fields of the data burst 440A may be transmitted from the TRP 102 using different methods and/or parameters in accordance with progressive link adaptation. More specifically, the first-stage WUS 466 may be a low-power waveform (same or different to that of the LCM signal) such as an OOK signal, a FSK signal, a PSK signal, a chirp or FMCW signal, a passive signal, or the like. The TRP 102 may start the transmission of the data burst 440A by transmitting the fast-wakeup signal 442, the AGC 444, and the first DL data set 446A using an initial determination of precoding, BF, and one or more MCS parameters, which may be determined based on the detection and measurements of the periodic LCM signals or sensing information, or may be obtained from the communication-parameter map 372 based on the UE’s latest position/location obtained from the latest measurement. Then, after the transmission of the first DL data set 446A, the methods and/or parameters may be updated and used for transmission of the second DL data set 446B.

In some embodiments, the initial MCS selection for transmitting the fast-wakeup signal 442 may be a predefined, fixed value defined based on long-term channel estimation. The MCS for transmitting the first DL data set 446A or the first DL data field 446-1 of the first DL data set 446A may be determined based on channel quality or MCS estimation obtained from the latest LCM signal, based on sensing information obtained from the latest LCM signal, or from the communication-parameter map 372 based on the UE’s latest position/location obtained from the latest measurement. Then, the MCS for the transmission of subsequent DL data set (such as the second DL data set 446B) or subsequent data field (such as the data field 446-2) may be updated based on the measurement results such as the measurement results of MCS obtained after the transmission of previous DL data set 446A or DL data field 446-1.

In other embodiments, other MCS update/adaptation methods may also be used. For example, in some embodiments, the MCS for transmitting the first DL data set 446A or the first DL data field 446-1 of the first DL data set 446A may be determined based on channel quality or MCS estimation obtained based on the feedback from the UE’s channel measurements using the RS in the fast-wakeup signal 442, RS in the first data set, or new sensing result obtained by the UE 114 or TRP 102. This way the updated MCS can be applied only after the TRP 102 receives the measurement results from the UE 114. The MCS for the transmission of subsequent data set (such as the second data set 446B) or subsequent data field (such as the data field 446-2) may be updated based on the measurement results such as the measurement results of MCS obtained after the transmission of previous DL data set 446A or DL data field 446-1.

In some embodiments, the TRP 102 may adjust MCS based on data decoding performance before receiving new measurement results. For example, the MCS for transmitting the first DL data field 446-1 of the first DL data set 446A may be determined based on data decoding performance (which may be derived from the soft ACK/NACK) of the second-stage wakeup signal 468. The MCS for transmitting the second DL data field 446-2 of the first DL data set 446A may also be determined based on data decoding performance (which may be derived from the soft ACK/NACK) of the first DL data field 446-1.

In some embodiments, the TRP 102 may change coding rate with progressive MCS adaptation mechanism during the transmissions of the DL data fields 446-1 and 446-2 of the first DL data set 446A such that a later transmitted DL data field 446-2 may better adapt to the channel compared to a previously transmitted DL data field 446-1.

In accordance with the initial MCS selection, the initial modulation order may be selected only from a set of low modulation levels such as binary phase shift keying (BPSK), quadrature phase shift keying (QPSK), or a small-constellation quadrature amplitude modulation (QAM) such as 16 QAM due to the possible imperfect time synchronization, channel quality estimation, and beam management.

However, the initial transmission code rate does not have the same limitation as the modulation order, and may use any suitable transmission code rate. Therefore, the code rate and modulation order may not be in the same row of the MCS table (that is, they may not follow the coding rate and modulation level combination defined in MCS table), as is done in existing standards. For example, in some embodiments, rateless codes (such as low-density parity check (LDPC) codes or polar codes) based flexible-rate code (with fixed payload size K) for a wide range of code rates (between a minimum code rate Rmin and a maximum code rate Rmax) may be used for coding rate adaptation. Then, a transmitter (such as the TRP 102) may send N ₁ bits first and N ₂ bits subsequently. The receiver (such as the UE 114) may opportunistically decode the N ₁ bits first, and then jointly decode the N ₁ + N ₂ bits if the first decoding attempt of the N ₁ bits fails.

In some embodiments, the power control in transmitting the fast-wakeup signal 442 may be semi-statically configured according to the UE’s long-term path loss (such as the system information block (SIB), RRC, or the like).

As described above, the MCS for the transmission of subsequent data fields (such as the second DL data field 446-2 after the transmission of the first DL data field 446-1) or subsequent data sets (such as the second DL data set 446B after the transmission of the first DL data set 446A) may be adjusted, for example, based on the newly obtained channel measurement information, previous available information, or more accuracy sensing results. The MCS for the transmission of subsequent data fields may also be adjusted based on enhanced MIMO scale or BF accuracy. The MCS for the transmission of subsequent data fields or data sets may be further adjusted based on soft ACK/NACK which may carry decoding quality information or quantized channel measurement information.

For example, referring again to FIG. 10, in some embodiments, the transmission of the first DL data set 446A may use a wide beam or use reduced-scale MIMO (such as using a predetermined antenna port number that is less than the maximum MIMO capacity or capability). On the other hand, the second DL data set 446B may be transmitted using a narrow beam (for example, the angular width of the beam for transmitting the second DL data set 446B being narrower than that of the beam for transmitting the first DL data set 446A) or using increased antenna capability or the maximum MIMO capability. In some embodiments, the first DL data set 446A may comprise a single RS that may be used for multiple purposes (such as being used as DMRS, CSI-RS, and PTRS to avoid the need of transmitting three types of RS, thereby reducing the overhead), and may be associated with the measurement result report.

In some embodiments, the power control in transmitting the first DL data set 446A may use one or more power-control parameters derived or otherwise obtained from a path loss estimation (such as a long-term path loss estimation, obtained from, for example, the LCM signal or communication-parameter map), and one or more predefined transmission parameters (such as one or more MIMO parameters).

In some embodiments, the second DL data field 446-2 of the first DL data set 446A may be the same as the first DL data field 446-1 (that is, a retransmission of the first DL data field 446-1). In some other embodiments, the second DL data field 446-2 may comprise different data and is not a retransmission of the first DL data field 446-1. The transmission of the second DL data field 446-2 may use the same parameters as that of the first DL data field 446-1.

In some embodiments, the transmission of the second DL data set 446B (such as the third DL data field 446-3 and the fourth data field 446-4) may be scheduled with updated DCI obtained based on the measurement results obtained based on the transmission of the previous DL data set 446A, and with enhanced parameters or configurations such as MIMO configuration (such as more antenna ports, higher ranks, more co-paired UEs, and/or the like).

In some embodiments, the power control in transmitting the second DL data set 446B may use one or more power-control parameters adjusted from those used in the transmission of the first DL data set 446A based on newly obtained channel measurements, sensing results, and/or one or more transmission and MIMO parameters.

FIG. 15 shows the structure of the DL data burst 440A transmitted from the TRP 102 to the UE 114 in the fast wakeup and data transmission method 400A, according to some embodiments of this disclosure, wherein the TRP 102 has full duplex capability or subband full duplex capability. The DL data burst 440A comprises a plurality of fields such as a WUS 442, an optional AGC head 444, and one or more DL data fields 446 (such as DL data fields 446-1 to 446-4), which are similar to those shown in FIG. 10. Similarly, the DL data fields 446 may be partitioned into a first DL data set 446A of one or more DL data fields 446-1 and 446-2 (transmitted at step 404), and a second DL data set 446B of one or more DL data fields 446-3 and 446-4 (transmitted at step 410).

A UCI and UL data field 462 (similar to that shown in FIG. 10) may be transmitted from the UE 114 to the TRP 102 within the time duration of the first DL data set 446A (such as within the time duration of the second DL data field 446-2 after a delay 464 from the starting time of the second DL data field 446-2), and may occupy a portion of the bandwidth (as shown in FIG. 15) or the entire bandwidth. The time/frequency resource used for transmission of the UCI and UL data field 462 in DL data transmission period may be pre-configured or signaled by wake up signal or follow up DCI. The delay 464 may be configured by RRC and may be updated by DCI.

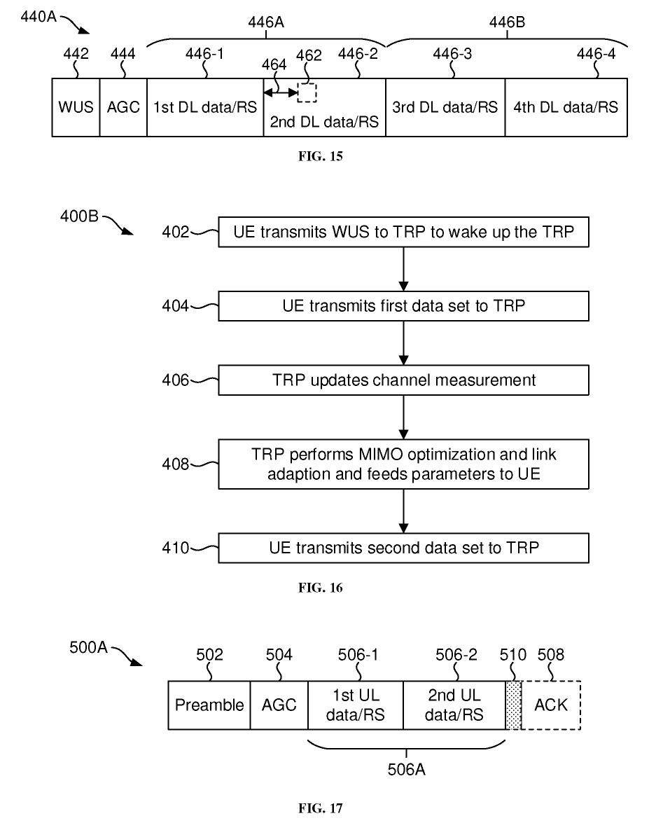

FIG. 16 is a flowchart showing the steps of a fast wakeup and data transmission method 400B performed by a TRP 102 and a UE 114 to wake up the TRP 102 in the sleep state 344, and transmit one or more UL data sets from the UE 114 to the TRP 102 (that is, UL data transmission) before the TRP 102 transitions to the connected state 342, according to some embodiments of this disclosure.

At step 402, the TRP 102 is woken up by, for example, a fast-wakeup signal (such as a wakeup preamble) sent from the UE 114 to the TRP 102. At step 404, a first UL data set having one or more UL data fields (that is, the first data transmission) is transmitted from the UE 114 to the TRP 102. The first UL data set is organized in accordance with a self-contained data-burst structure, which comprises a self-contained multi-purpose RS including channel estimation, channel acquisition, phase noise compensation, time and frequency synchronization, and/or the like.

In these embodiments, the data transmission may start with grant-free (also denoted “configured grant”) transmission (for example, the transmission in the first one or more slots being grant-free transmission) with information (such as MIMO-related information) obtained from the communication-parameter map stored in the UE 114, and the subsequent data transmission may be grant-based transmission.

At step 406, the TRP 102 receives the first UL data set and performs the channel measurements based on the first UL data set. For example, CSI may be updated based on the received first UL data set (or the RS therein), the DMRS, the decoded data, the new environment/channel sensing results, and/or the like.

At step 408, the TRP 102 uses the updated channel measurements for optimizing the connection between the UE 114 and TRP 102 such as BF optimization, MIMO optimization, link adaption, and/or the like for subsequent UL data transmission (such as a second UL data set). Those skilled in the art will appreciate that the “optimization” at this step is based on the updated channel measurements and does not necessarily achieve the optimized results that maximize the data transmission performance (which will be ultimately achieved in the connected state). However, such a “limited” optimization may be repeated with subsequent data transmissions to achieve progressive link adaption.

For example, in the BF and/or MIMO optimization, the MCS may be adjusted based on the updated channel measurements for subsequent UL data transmission. Moreover, the BF and/or MIMO optimization may be based on the updated channel measurements, new environment and/or channel sensing results, required data rate, power saving requirements, and/or the like. The TRP 102 may send the updated channel measurements and/or optimized communication parameters obtained at steps 406 and 408 to the UE 114.

After the first data transmission step 404, the UE 114 may go back to “sleep” (that is, remaining in the sleep state 344) without waiting for TRP’s feedback.

Alternatively, at step 410, the UE 114 may receive the TRP’s feedback to decide whether retransmission is required. The UE 114 also receives the optimized communication parameters from the TRP 102, and uses the received optimized communication parameters to transmit more data sets.

FIG. 17 shows the structure of the UL data burst 500A for transmitting from the UE 114 to the TRP 102 in the fast wakeup and data transmission method 400B, according to some embodiments of this disclosure. As shown, the UL data burst 500A comprises a plurality of fields such as a fast-wakeup preamble 502 (or simply denoted a “preamble”) comprising a fast-wakeup signal to wake up the TRP 102, an optional AGC head 504, and a set of one or more UL data fields 506 (including, for example, UL data fields 506-1 and 506-2, each of which may comprise one or more RS). The preamble 502 and the optional AGC head 504 are transmitted at step 402 shown in FIG. 16, and the UL data set 506 is transmitted at step 404 (that is, the first data transmission). A DL ACK 508 may be transmitted from the TRP 102 to the UE 114 after a DL/UL switch gap 510 from the ending time of the UL data set 506. In this example, the UE 114 receives updated transmission parameters from TRP 102 and maintains itself in the sleep state after the first data transmission 404.

The preamble 502 may be used for UL timing synchronization, UE identification, initial channel estimation and/or acquisition, position measurements or updates, sensing measurements or updates, and/or the like, which, in some embodiments, is also used as a WUS to wake up the TRP 102. Alternatively, a WUS for waking up the TRP 102 may be used as the preamble 502.

In some embodiments, the power control in transmitting the preamble 502 may be semi-statically configured according to the UE’s long-term path loss (such as the system information block (SIB), RRC, or the like), or may be configured or otherwise determined by the UE 114.

The AGC head 504 is optional, meaning that, in some embodiments, the UL data burst 500A comprises the AGC head 504 for the TRP 102 to adjust dynamic range of the received power, or in some other embodiments, the UL data burst 500A does not comprise any AGC head 504.

In some embodiments, the UL data burst 500A may comprise a predefined or customized time gap between the preamble 502 and the AGC head 504. In some embodiments, the UL data burst 500A may comprise a predefined or customized time gap between the AGC head 504 and the first UL data field 506-1. In some embodiments wherein the AGC head 504 is not used, the UL data burst 500A may comprise a predefined or customized time gap between the preamble 502 and the first UL data field 506-1.

Similar to the DL data field 446 shown in FIG. 12 or 13, in some embodiments, a UL data field 506 (such as the first UL data field 506-1 or the second UL data field 506-2) may comprise one or more data symbols 472 and one or more RS symbols 474 (wherein the RS symbols may be any suitable RS such as DMRS, SRS, and/or the like), and may further comprise one or more DCI subfields 476. Moreover, the one or more RS symbols 474 may be in any suitable locations in the UL data field 506 such as in dedicated symbol locations or multiplexed with the data symbols in a same OFDM symbol or DFT-s-OFDM symbol.

In some embodiments, the power control in transmitting the UL data set 506 (such as UL data fields 506-1 and 506-2) may use one or more power-control parameters derived or otherwise obtained from a path loss estimation (such as a long-term path loss estimation, obtained from, for example, the LCM signal or communication-parameter map), and one or more predefined transmission parameters (such as one or more MIMO parameters).

In some embodiments, the UL data burst 500A may be started with grant-free or configured grant transmission based on one or more predefined channel resources and transmission parameters. In some embodiments, the UE 114 may adjust one or more transmission parameters based on received DCI for improving spectrum efficiency.

After receiving UL data burst 500A, the TRP 102 may obtain updated one or more transmission parameters from the preamble 502 and/or the RS symbols in the one or more UL data fields 506.

FIG. 18 shows the structure of the UL data burst 500A for transmitting from the UE 114 to the TRP 102 in the fast wakeup and data transmission method 400B, according to some embodiments of this disclosure. As shown, the UL data burst 500A comprises a plurality of fields such as a preamble 502 comprising a fast-wakeup signal to wake up the TRP 102, an optional AGC head 504, and a set of one or more UL data fields 506. The preamble 502 and the optional AGC head 504 are transmitted at step 402 shown in FIG. 16. The one or more UL data fields 506 include, for example, a first UL data set 506A (including one or more UL data fields such as UL data fields 506-1 and 506-2) transmitted at step 404 (that is, the first data transmission), and a second UL data set 506B (including one or more UL data fields such as UL data fields 506-3 and 506-4) transmitted at step 410 (that is, the second data transmission).

The first UL data set 506A and the second UL data set 506B are separated in time by a time period 512 for the TRP 102 to transmit a DL feedback 508 (which may be a DCI and DL ACK) to the UE 114. A DL/UL switch gap 510 may be maintained between neighboring data-burst portion and the UCI/UL data 462, such as a DL/UL switch gap 510A between the first UL data set 506A and the DCI/DL ACK 508, and a DL/UL switch gap 510B between the DCI/DL ACK 508 and the second UL data set 506B, for reducing or eliminating interference. The DL/UL switch gaps 510 may be configured based on for example the switching time required by device, propagation delay, and/or the like.

The preamble 502, AGC 504, and first UL data set 506A, as well as the transmission and receiving thereof, are similar to the preamble 502, AGC 504, and UL data set 506 shown in FIG. 17. For example, in some embodiments, the power control in transmitting the first UL data set 506A (such as UL data fields 506-1 and 506-2) may use one or more power-control parameters derived or otherwise obtained from a path loss estimation (such as a long-term path loss estimation, obtained from, for example, the LCM signal or communication-parameter map), and one or more predefined transmission parameters (such as one or more MIMO parameters).

In some embodiments, the power control in transmitting the second UL data set 506B (such as UL data fields 506-3 and 506-4) may use one or more power-control parameters adjusted from those used in the transmission of the first UL data set 506A based on newly obtained one or more channel measurements, one or more sensing results, and/or one or more transmission and MIMO parameters (carried by DCI or new RRC signal). Alternatively, the power control in transmitting the second UL data set 506B may be configured or otherwise determined by the UE 114.

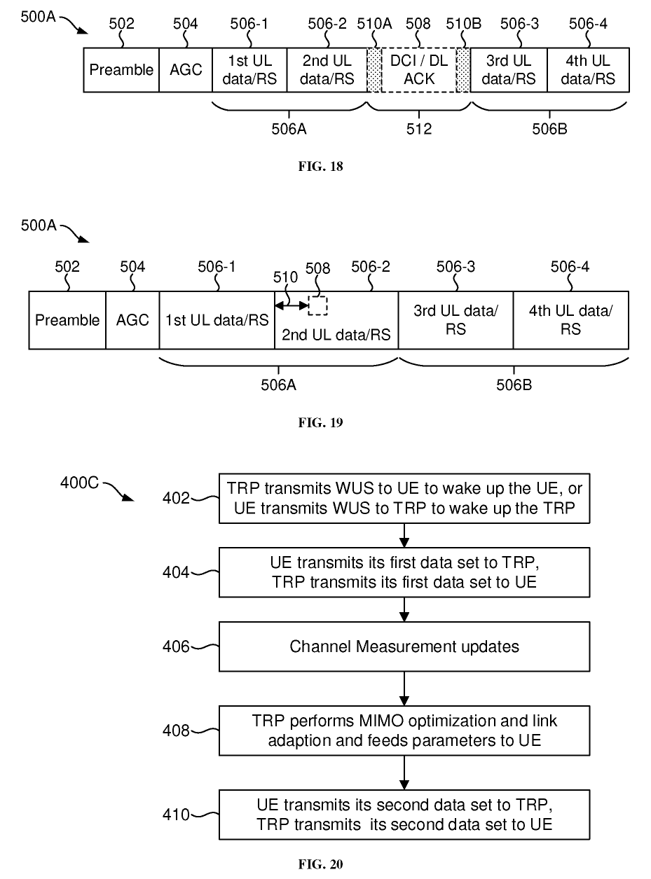

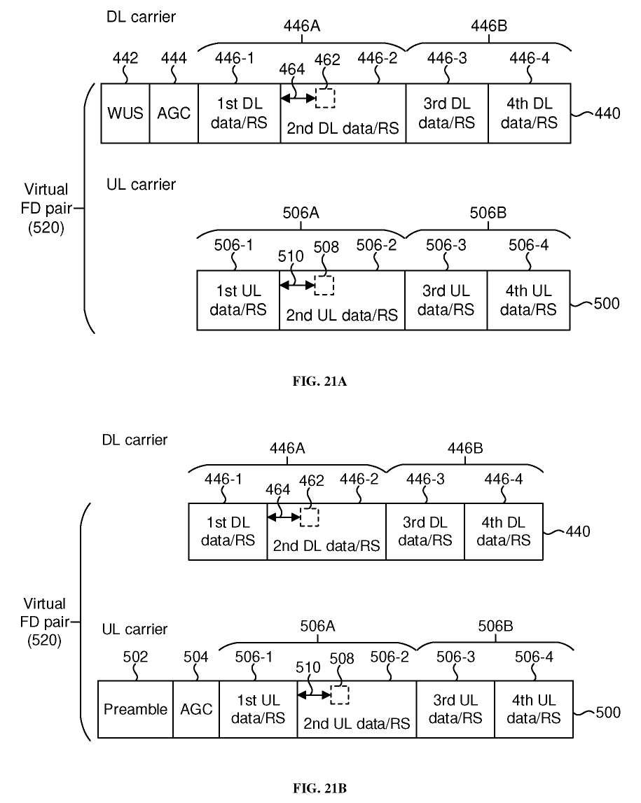

FIG. 19 shows the structure of the UL data burst 500A for transmitting from the UE 114 to the TRP 102 in the fast wakeup and data transmission method 400B, according to some embodiments of this disclosure. As shown, the UL data burst 500A comprises a plurality of fields such as a preamble 502 comprising a fast-wakeup signal to wake up the TRP 102, an optional AGC head 504, and one or more UL data fields 506. The preamble 502 and the optional AGC head 504 are transmitted at step 402 shown in FIG. 16. The one or more UL data fields 506 include, for example, a first UL data set 506A (including one or more UL data fields such as UL data fields 506-1 and 506-2) transmitted at step 404 (that is, the first data transmission), and a second UL data set 506B (including one or more UL data fields such as UL data fields 506-3 and 506-4) transmitted at step 410 (that is, the second data transmission).

A DCI and DL ACK 508 (similar to the DCI and DL ACK 508 shown in FIG. 18) may be transmitted from the TRP 102 to the UE 114 within the time duration of the first UL data set 506A (such as within the time duration of the second UL data field 506-2 after a delay 510 from the starting time of the second UL data field 506-2), and may occupy a portion of the bandwidth (as shown in FIG. 19) or the entire bandwidth. The DL/UL switch gap 510 may be configured by RRC and may be updated by DCI.

FIG. 20 is a flowchart showing the steps of a fast wakeup and data transmission method 400C performed by a TRP 102 and a UE 114 to wake up the TRP 102 and the UE 114 in the sleep state 344, and transmit one or more UL data sets from the UE 114 to the TRP 102 (that is, UL data transmission) and one or more DL data sets from the TRP 102 to the UE 114 (that is, DL data transmission) before the TRP 102 and the UE 114 transitions to the connected state 342, according to some embodiments of this disclosure. In these embodiments, the TRP 102 may use a DL carrier to send a DL data burst 440 (such as any of about-described DL data burst 440A or 440B) to the UE 114, and substantially at the same time, the UE 114 may use a UL carrier to send a UL data burst 500 (such as any of about-described DL data burst 500A or 500B) to the TRP 102, thereby achieving full-duplex (FD) or subband-FD fast-wakeup and data-transmission. The DL data burst 440 and the UL data burst 500 thus form a virtual FD pair 520.

The fast wakeup and data transmission method 400C is substantially a combination of the fast wakeup and data transmission methods 400A and 400B shown in FIGS. 9 and 16. More specifically, step 402 corresponds to that of the fast wakeup and data transmission method 400A shown in FIG. 9 and the corresponding step of the fast wakeup and data transmission method 400B, and each of steps 404 and 410 is the combination of, for example, the corresponding step of the fast wakeup and data transmission method 400A shown in FIG. 9 and the corresponding step of the fast wakeup and data transmission method 400B shown in FIG. 16. Steps 406 and 408 of the fast wakeup and data transmission method 400C may be performed by the TRP 102, the UE 114, or both.

The structures of the UL and DL data bursts in these embodiments are shown in FIGS. 21A or 21B. The difference is that in FIG. 21A, the TRP 102 sends a fast-wakeup signal 442 to the UE 114 via a DL carrier while in FIG. 21B, the UE 114 sends a wakeup preamble 502 to the TRP 102.

In some embodiments similar to that shown in FIG. 9, the UE 114 may send a wakeup preamble to the TRP 102 and then the TRP 102 sends one or more data fields 446 to the UE 114 in a similar manner as described above.

In some embodiments similar to that shown in FIG. 16, the TRP 102 may send a fast-wakeup signal to the UE 114 and then the UE 114 sends one or more data fields 446 to the TRP 102 in a similar manner as described above.

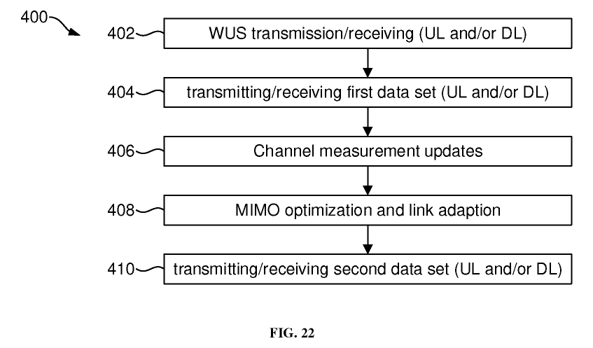

As shown in FIG. 22, the fast wakeup and data transmission methods 400A to 400C may be generalized as a fast wakeup and data transmission method 400 comprises the following steps:

Fast-wakeup signal transmission and receiving (step 402), which may be DL transmission (from a TRP 102 to a UE 114) or UL transmission (from a UE 114 to a TRP 102);

First data transmission and receiving (step 404), which may be DL transmission (from a TRP 102 to a UE 114) or UL transmission (from a UE 114 to a TRP 102);

Channel measurement updates, MIMO optimization, and link adaption (steps 406 and 408);

Second data transmission and receiving using updated communication parameters (step 410), wherein the transmission direction may be the same as or different to that of the first data transmission.

With the above description of the DL and UL data burst structures, the details of the fast wakeup and DL/UL transmission methods are now described.

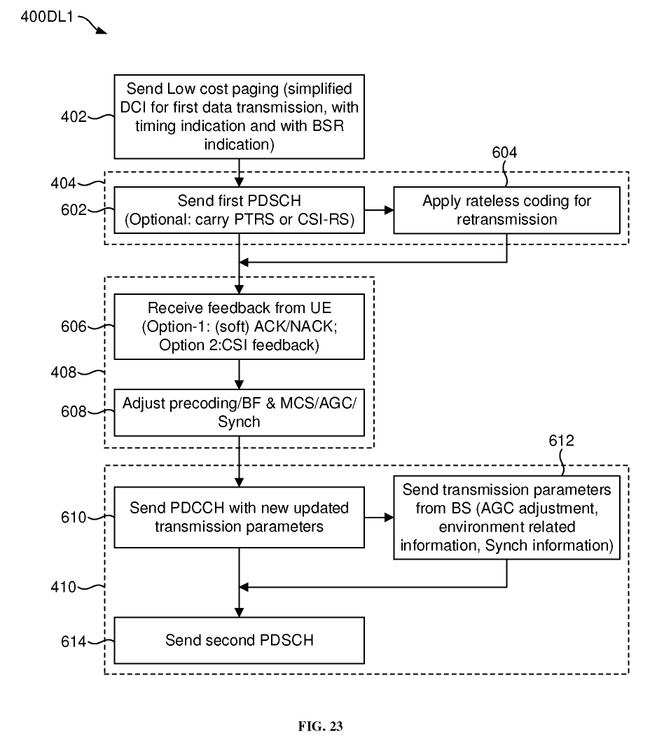

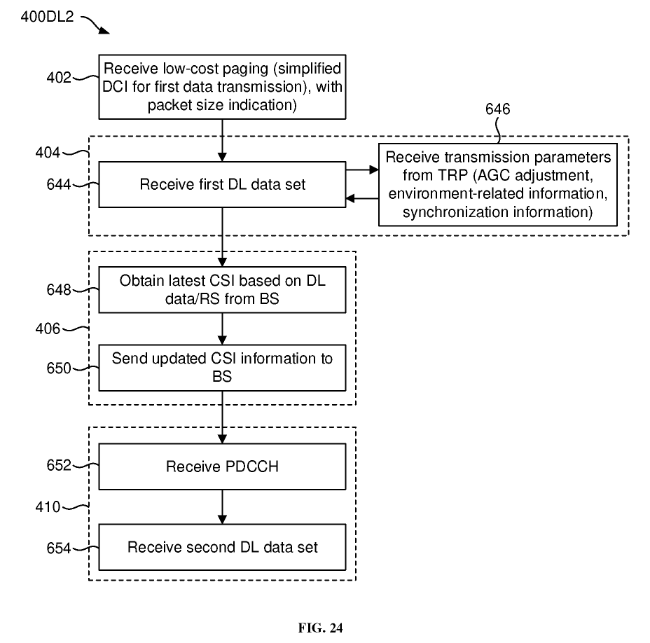

FIG. 23 is a flowchart showing the details of the fast wakeup and DL transmission method 400DL1 performed by a TRP 102 (corresponding to the fast wakeup and DL data transmission method 400A shown in FIG. 9), according to some embodiments of this disclosure.

At step 402, the TRP 102 transmits the low-cost fast-wakeup signal 442, which may be a single WUS (such as a simplified DCI for first transmission, with timing indication and optional buffer status reporting (BSR) indication) or a two-stage fast-wakeup signal including the first-stage WUS 466 and the second-stage WUS 468.

At step 602, the TRP 102 transmits the first PDSCH data (for example, sending the first DL data set 446A such as the first and second DL data fields 446-1 and 446-2; see FIG. 10) which may optionally carry PTRS or CSI-RS in accordance with the information in the second-stage WUS 468 (such as the time-frequency resource) and the information in the communication-parameter map related to the UE’s position (such as MIMO-related information). The TRP 102 may optionally apply rateless coding for retransmission of the first DL data set 446A (step 604). The combination of steps 602 and 604 correspond to step 404 shown in FIG. 9.

The UE 114 receives the fast-wakeup signal 442 and the first PDSCH data, performs communication-related measurements, and transmits feedback of the measurement results to the TRP 102 (step 406 shown in FIG. 9; also see FIG. 24).

The TRP 102 receives the feedback from the UE 114 (step 606), and then adjusts or otherwise updates one or more transmission parameters such as precoding, BF, MCS, AGC, synchronization, and/or the like (step 608). At this step, the TRP 102 may send ACK/NACK to the UE 114 to respond to feedback from UE 114. The combination of steps 606 and 608 correspond to step 408 shown in FIG. 9.

The TRP 102 then transmits the PDCCH with the updated transmission parameters (such as precoding, BF, MCS, AGC, synchronization, and/or the like) (step 610). The TRP 102 may also send one or more additional transmission parameters (for example, AGC adjustment, environment-related information, synchronization information, one or more power control parameters, and/or the like) to the UE 114 (step 612). At step 614, the TRP 102 transmits the second data PDSCH for sending the second DL data set 446B (such as the third and fourth DL data fields 446-3 and 446-4). The combination of steps 610 to 614 correspond to step 410 shown in FIG. 9.

FIG. 24 is a flowchart showing the details of the fast wakeup and DL data transmission method 400DL2 performed by a UE 114, corresponding to the fast wakeup and DL data transmission method 400DL1 performed by the TRP 102 (that is, also corresponding to the fast wakeup and DL data transmission method 400A shown in FIG. 9).

At step 402, the UE 114 receives the low-cost fast-wakeup signal 442 transmitted from the TRP 102. As described above, the fast-wakeup signal 442 may be a single WUS (such as a simplified DCI with packet size indication such as BSR) or a two-stage fast-wakeup signal including the first-stage WUS 466 and the second-stage WUS 468.

At step 644, the UE 114 receives the first DL data set 446A (such as the first and second DL data fields 446-1 and 446-2) from the TRP 102 using information in the second-stage WUS 468 (such as the time-frequency resource) and the information in the stored communication-parameter map (such as MIMO-related information). Optionally, the UE 114 also receives one or more transmission parameters (for example, AGC adjustment, environment-related information, synchronization information, and/or the like) from the TRP 102 for facilitating the receiving of the first DL data set 446A (step 646). The combination of steps 644 and 646 correspond to step 404 shown in FIG. 9.

Then, the UE 114 obtains the latest CSI based on the DL data and/or RS in the received DL data field 446-1 (step 648). At step 650, the UE 114 sends the updated CSI information to the TRP 102. The combination of steps 648 and 650 correspond to step 406 shown in FIG. 9.

At step 652, the UE 114 receives the PDCCH transmitted from the TRP 102 (at step 610 shown in FIG. 30). At step 654, the UE 114 receives the second DL data set 446B (such as the third and fourth DL data fields 446-3 and 446-4). The combination of steps 652 and 654 correspond to step 410 shown in FIG. 9.

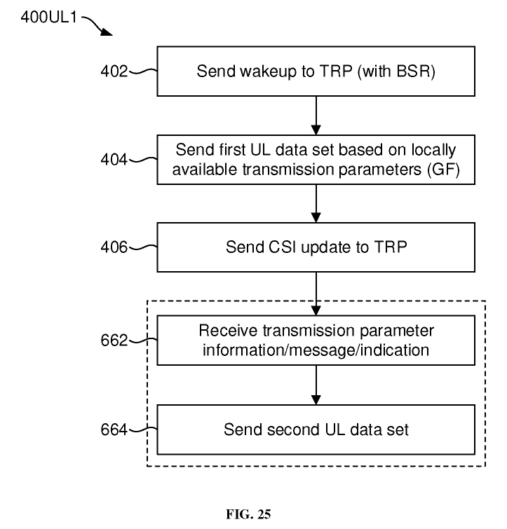

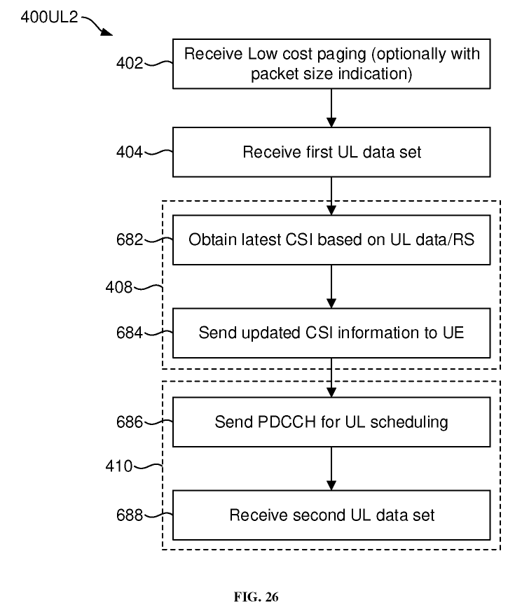

FIG. 25 is a flowchart showing the steps of the fast wakeup and UL transmission method 400UL1 performed by a UE 114 (corresponding to the fast wakeup and DL data transmission method 400B shown in FIG. 16), according to some embodiments of this disclosure.

At step 402, the UE 114 sends a fast-wakeup signal or preamble to the TRP 102 (with BSR). Then, the UE 114 sends the first UL data set 506A (such as the UL data fields 506-1 and 506-2) based on one or more locally available transmission parameters using grant-free (GF) or configured grant (CG) transmission method (step 404).

At step 406, the UE 114 may update channel measurements and optionally send the CSI update to the TRP 102. The TRP 102 uses the updated channel measurements for optimizing the connection between the UE 114 and TRP 102 (step 408 shown in FIG. 16).

At step 662, the UE 114 receives the information, message, or indication of the one or more transmission parameters. At step 664, the UE 114 sends the second UL data set 506B (such as the UL data fields 506-3 and 506-4).

FIG. 26 is a flowchart showing the steps of the fast wakeup and UL transmission method 400UL2 performed by a TRP 102, corresponding to the fast wakeup and UL data transmission method 400UL1 performed by the UE 114 (that is, also corresponding to the fast wakeup and DL data transmission method 400B shown in FIG. 16).

At step 402, the TRP 102 receives the low-cost fast wakeup preamble (optionally with packet-size indication), and then receives the first UL data set 506A (such as the UL data fields 506-1 and 506-2) at step 404. Optionally, TRP 102 receives the preamble following by the first data transmission with one or more predefined transmission parameters.

At step 682, the TRP 102 obtains the latest CSI, based on the received first UL data set 506A and the RS embedded therein. At step 684, the TRP 102 sends the updated CSI information to the UE 114. The combination of steps 682 and 684 correspond to step 408 shown in FIG. 16.

At step 686, the TRP 102 sends PDCCH to the UE 114 for UL scheduling. At step 688, the TRP 102 receives the second UL data set 506B (such as the third and fourth UL data fields 506-3 and 506-4). The combination of steps 686 and 688 correspond to step 410 shown in FIG. 16.

As those skilled in the art will appreciate, state transition usually requires certain overhead. Therefore, in some embodiments, the TRP 102 and/or UE 114 does not transition between different states. Rather, the TRP 102 and/or UE 114 may perform the fast wakeup and data transmission methods disclosed herein when at least one of the TRP 102 and/or UE 114 is in restricted or reduced power consumption for wireless communication related activities (in other words, with a restricted or reduced wireless communication capability). After data transmission/receiving, the device or devices remain in the same power consumption level or change to increased, less restricted, unrestricted, or even full power consumption for wireless communication related activities (that is, with increased or even full wireless communication capability). While a device in restricted or reduced power consumption for wireless communication related activities may appear to be similar to the RRC_INACTIVE state and the device, and a device in increased, less restricted, unrestricted, or even full power consumption for wireless communication related activities may appear to be similar to the RRC_CONNECTED state, the “stateless” embodiments disclosed herein is significantly different to the RRC states in that, in the “stateless” embodiments disclosed herein, the devices do not need state transition thereby eliminating the overhead associated therewith.

As those skilled in the art will appreciate, various apparatuses, devices, components, modules, and/or the like in the communication system 100 that perform communication functions may be generally denoted “communication nodes” or simply “nodes”. For example, TRPs 102 and UEs 114 are communication nodes, wherein TRPs 102 may also be denoted “network nodes” or “access nodes” as the TRPs 102 provide or otherwise enables the UE’s access to the RANs 102.

The above-described method applies to a wide range of communication networks, such as 5G+, 6G, WI-FI^{®} (WI-FI is a registered trademark of Wi-Fi Alliance, Austin, TX, USA), non-terrestrial networks (NTNs), and distributed or self-organized networks.

### E. DEFINITIONS OF SOME TERMS

Herein, the term “one shot self-contained data transmission” or “one shot data transmission” specifically refers to the simplified process for rapid data transmission including receiving wakeup signal, performing minimum channel measurement, and transmitting/receiving a not-too-large amount of data.

Herein, the term “predefined” (for example, a “predefined” item such as a “predefined” parameter) refers to an item defined before the fast wakeup and data transmission method disclosed herein is performed (for example, defined as a system design parameter such as defined by relevant standards).

Herein, the term “preconfigured” (for example, a “preconfigured” item such as a “preconfigured” parameter) refers to an item configured (for example, by a TRP 102) before a certain event occurs. For example, in some embodiments, a preconfigured item may be configured before the TRP 102 and/or UE 114 entered reduced power consumption or the sleep state. In some embodiments, a preconfigured item may be configured before the wakeup signal or the wakeup preamble is transmitted.

Herein, each of the expression “at least one of A, B, and C” and the expression “at least one of A, B, or C” refers to “A, B, C, or a combination thereof”, or “at least one selected from the group of A, B, and C”.

Herein, various embodiments of the fast wakeup and data transmission methods are described. In various embodiments, the fast wakeup and data transmission methods disclosed herein may be implemented as hardware, software, firmware, or a combination thereof, and may be implemented in any suitable form. Depending on the functionalities of various features of the methods disclosed herein, some features may be implemented on the network side (such as in one or more TRPs), some other features may be implemented on the UE side, and/or yet some other features may be implemented on both the TRP and the UE sides. Depending on the functionalities of various features of the methods disclosed herein, some features may be implemented on the transmitting side (such as in one or more TRPs and/or one or more UEs for transmission), some other features may be implemented on the receiving side (such as in one or more TRPs and/or one or more UEs for receiving), and/or yet some other features may be implemented on both the transmitting and the receiving sides.

For example, in some embodiments, the fast wakeup and data transmission methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the fast wakeup and data transmission methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method applied in a first communication node for wireless communication with a second communication node, at least one of the first communication node or the second communication node being in reduced power consumption for wireless communication related activities, the method comprising:
transmitting to the second communication node a wakeup signal in accordance with a first set of communication-related information, the wakeup signal comprising control information; and
transmitting to the second communication node a first data set in accordance with the control information in the wakeup signal and a second set of communication-related information.

2. The method of claim 1, wherein the first data set is transmitted without a channel measurement period before the transmitting the first data set and after the transmitting the wakeup signal.

3. The method of claim 1, wherein the second set of communication-related information is determined before the transmitting the wakeup signal.

4. The method of claim 1, wherein the at least one of the first communication node or the second communication node is in a sleep state during communicating the wakeup signal and the first data set.

5. The method of claim 1, wherein the first set of communication-related information and the second set of communication-related information are stored in a communication-parameter map, and
wherein the communication-parameter map comprises one or more entries, each entry of the one or more entries comprising communication-related information for one or more zones of an area.

6. A method applied in a second communication node for wireless communication with a first communication node, at least one of the first communication node or the second communication node being in reduced power consumption for wireless communication related activities, the method comprising:
receiving from the first communication node a wakeup signal based on a first set of communication-related information, the wakeup signal comprising control information; and
receiving from the first communication node a first data set based on the control information in the wakeup signal and a second set of communication-related information.

7. The method of claim 6, wherein the first data set is received without a channel measurement period before the receiving the first data set and after the receiving the wakeup signal.

8. The method of claim 6, wherein the second set of communication-related information is determined before the receiving the wakeup signal.

9. The method of claim 6, wherein the at least one of the first communication node or the second communication node is in a sleep state during communicating the wakeup signal and the first data set.

10. The method of claim 6, wherein the first set of communication-related information and the second set of communication-related information are stored in a communication-parameter map, and
wherein the communication-parameter map comprises one or more entries, each entry of the one or more entries comprising communication-related information for one or more zones of an area.

11. A first communication node for wireless communication with a second communication node, at least one of the first communication node or the second communication node being in reduced power consumption for wireless communication related activities, the first communication node comprising:
at least one processor coupled with at least one memory storing one or more instructions that are capable of being run on the at least one processor, wherein, when the one or more instructions are run, the first communication node is enabled to:
transmit to the second communication node a wakeup signal in accordance with a first set of communication-related information, the wakeup signal comprising control information; and
transmit to the second communication node a first data set in accordance with the control information in the wakeup signal and a second set of communication-related information.

12. The first communication node of claim 11, wherein the first data set is transmitted without a channel measurement period before transmitting the first data set and after transmitting the wakeup signal.

13. The first communication node of claim 11, wherein the second set of communication-related information is determined before transmitting the wakeup signal.

14. The first communication node of claim 11, wherein the at least one of the first communication node or the second communication node is in a sleep state during communicating the wakeup signal and the first data set.

15. The first communication node of claim 11, wherein the first set of communication-related information and the second set of communication-related information are stored in a communication-parameter map, and
wherein the communication-parameter map comprises one or more entries, each entry of the one or more entries comprising communication-related information for one or more zones of an area.

16. A second communication node for wireless communication with a first communication node, at least one of the first communication node or the second communication node being in reduced power consumption for wireless communication related activities, the second communication node comprising:
receiving from the first communication node a wakeup signal based on a first set of communication-related information, the wakeup signal comprising control information; and
receiving from the first communication node a first data set based on the control information in the wakeup signal and a second set of communication-related information.

17. The second communication node of claim 16, wherein the first data set is received without a channel measurement period before receiving the first data set and after receiving the wakeup signal.

18. The second communication node of claim 16, wherein the second set of communication-related information is determined before the receiving the wakeup signal.

19. The second communication node of claim 16, wherein the at least one of the first communication node or the second communication node is in a sleep state during communicating the wakeup signal and the first data set.

20. The second communication node of claim 16, wherein the first set of communication-related information and the second set of communication-related information are stored in a communication-parameter map, and
wherein the communication-parameter map comprises one or more entries, each entry of the one or more entries comprising communication-related information for one or more zones of an area.
